(19) United States
(12) Patent Application Publication
(10) Pub. No.: US 2005/0084789 A1
(43) Pub. Date: Apr. 21, 2005

(54) Pressure developable imaging element with improved support

(75) Inventors: Sandra J. Dagan, Churchville, NY (US); Terry A. Heath, Caledonia, NY (US); Alphonse D. Camp, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/688,089

(22) Filed: Oct. 17, 2003

(51) Int. Cl. G03C 1/72

(52) U.S. Cl. 430/138

(57) ABSTRACT

This invention relates to a pressure developable imaging element comprising a support and an image forming unit comprising photosensitive microcapsules and a developer, wherein said support comprises a substrate comprising polyolefin or a copolymer thereof, wherein said substrate has a density of greater than 0.9 grams/cc.

### FIELD OF THE INVENTION

This invention relates to a light sensitive and pressure developable imaging element comprising an image forming unit comprising photosensitive microcapsules, said imaging element further comprising a high density synthetic paper support.

### BACKGROUND OF THE INVENTION

In recent years various dry-type image-imaging processes which utilize a color-forming component capable of generating visible images by coloration or discoloration reaction have been disclosed in the patent literature. These imaging processes do not use a liquid developing solution or the like and therefore do not generate wastes. Both light sensitive and heat developable and light sensitive and pressure developable processes have been discussed in great detail. Both processes utilize a photopolymerization composition to create a latent image by irradiating the imaging element with light through an image original. The latent image is composed of domains exposed to light at different degrees (from unexposed to fully exposed areas). The fully exposed domains have the highest degree of hardening and the unexposed domains have lowest degree of hardening. Under heat or pressure or both, a visible image is formed due to the difference in the mobility of the color-forming component; said mobility being controlled by the degree of hardening. For example., in the unexposed area the color-forming component can move freely to allow a color formation reaction., and in the fully exposed area the color-forming component cannot move, thereby inhibiting a color formation reaction.

Imaging systems employing microencapsulated radiation sensitive compositions have been disclosed in U.S. Pat. Nos. 4,399,209; 4,416,966; 4,440,846; 4,766,050; and 5,783,353. These imaging systems are characterized in that an imaging sheet including a layer of microcapsules containing a photohardenable composition in the internal phase is image-wise exposed to light. In the most typical embodiments, the photohardenable composition is a photopolymerization composition including a polyethylenically unsaturated compound and a photoinitiator. A color former is encapsulated with the photopolymerization composition. Exposure to light hardens the internal phase of the microcapsules. Following exposure, the imaging sheet is developed by subjecting it to a uniform rupturing force in the presence of a developer.

An image transfer system in which the developer material is coated on a separate substrate as a separate developer or copy sheet is disclosed in U.S. Pat. No. 4,399,209. A self-contained imaging system in which the encapsulated color former and the developer material are present in one layer or in two interactive layers is disclosed in U.S. Pat. No. 4,440,846. Self-contained imaging systems having an opaque support are disclosed in commonly assigned U.S. Pat. No. 6,080,520. A two-sided imaging material is disclosed in commonly assigned U.S. Pat. No. 6,030,740.

The imaging system is capable of providing a full color imaging material in which the microcapsules are in three sets containing cyan, magenta, and yellow color formers respectively sensitive to red, green, and blue light. For good color balance, the light sensitive microcapsules are sensitive (λ max) at about 450 nm, 540 nm, and 650 nin, respectively. Such a system is useful with visible light sources in direct transmission of reflection imaging. It is further useful in making contact prints, projected prints of color photographic slides, or in digital printing. It is also useful in electronic imaging using lasers or pencil light sources of appropriate wavelengths. Because digital imaging systems do not require the use of visible light, sensitivity can be extended into the UV and IR to spread the absorption spectra of the photoinitiators and avoid cross talk.

One problem with the use of pressure developable imaging elements has been finding the appropriate support for the element. In order for an imaging print support to be widely accepted by the consumer for imaging applications, it has to meet requirements for preferred basis weight, caliper, stiffness, smoothness, gloss, whiteness, and opacity. Supports with properties outside the typical range for ‘imaging media’ suffer low consumer acceptance.

In addition to these fundamental requirements, imaging supports are also subject to other specific requirements depending upon the mode of image formation onto the support. With regard to pressure developable imaging elements the support must be firm enough that all of the unexposed microcapsules will rupture when the element is pressure developed. If the support cushions the microcapsules, the Dmax of the imaging element may be affected.

It is important, therefore, for an imaging media to simultaneously satisfy several requirements. One commonly used technique in the art for simultaneously satisfying multiple requirements is through the use of composite structures comprising multiple layers wherein each of the layers, either individually or synergistically, serves distinct functions. For example, it is known that a conventional photographic paper comprises a cellulose paper base that has applied thereto a layer of polyolefin resin, typically polyethylene, on each side, which serves to provide waterproofing to the paper and also provides a smooth surface on which the photosensitive layers are formed. In another imaging material as in U.S. Pat. No. 5,866,282, biaxially oriented polyolefin sheets are extrusion laminated to cellulose paper to create a support for silver halide imaging layers. The biaxially oriented sheets described therein have a microvoided layer in combination with coextruded layers that contain white pigments such as TiO₂ above and below the microvoided layer. The composite imaging support structure described has been found to be more durable, sharper, and brighter than prior art photographic paper imaging supports that use cast melt extruded polyethylene layers coated on cellulose paper. In U.S. Pat. No. 5,851,651, porous coatings comprising inorganic pigments and anionic, organic binders are blade coated to cellulose paper to create ‘photo-quality’ inkjet paper.

In all of the above imaging supports, multiple operations are required to manufacture and assemble all of the individual layers. For example, photographic paper typically requires a papermaking operation followed by a polyethylene extrusion coating operation, or as disclosed in U.S. Pat. No. 5,866,282, a paper-making operation is followed by a lamination operation for which the laminates are made in yet another extrusion casting operation. There is a need for imaging supports that can be manufactured in a single in-line manufacturing process while still meeting the stringent features and quality requirements of imaging bases.

It is also well known in the art that traditional imaging bases consist of raw paper base. For example, in typical photographic, approximately 75% of the weight of the photographic paper comprises the raw paper base. Although raw paper base is typically a high modulus, low cost material, raw paper base is too rough and nonuniform to be used with pressure developed elements. Further, there exist significant environmental issues with the paper manufacturing process. There is a need for alternate raw materials and manufacturing processes that are more environmentally friendly. Additionally to minimize environmental impact, it is important to reduce the raw paper base content, where possible, without sacrificing the imaging base features that are valued by the customer, i.e. strength, stiffness, surface properties and the like, of the imaging support.

An important corollary of the above is the ability to recycle the paper support. Current photographic papers cannot be recycled because they are composites of polyethylene and raw paper base and, as such, cannot be recycled using polymer recovery processes or paper recovery processes. An imaging element support comprises significantly higher contents of polymer lends itself to recycling using polymer recovery processes.

Existing composite paper structures are typically subject to curl through the manufacturing, finishing, and processing operations. This curl is primarily due to internal stresses that are built into the various layers of the composite structure during manufacturing and drying operations, as well as during storage operations (core-set curl). Additionally, since the different layers of the composite structure exhibit different susceptibility to humidity, the curl of the imaging base changes as a function of the humidity of its immediate environment. There is a need for an imaging support that minimizes curl sensitivity as a function of humidity, or ideally, does not exhibit curl sensitivity.

The stringent and varied requirements of imaging media, therefore, demand a constant evolution of material and processing technology. The idea of an all polymer “synthetic” paper has been around for years. Use of these synthetic papers has been tried in imaging media with limited success (U.S. Pat. No. 5,275,854.) However, these “papers” traditionally fail to meet imaging needs for a variety of reasons such as weak, plastic-like feel and relatively high cost. Synthetic papers in the past have been 3 to 4 times more expensive than media manufactured from cellulose fiber. Schut, J. H., “The New Look in Plastic—It's Paper!”. Plastics Technology, Gardner Publications, Inc., New York, N.Y., February 2000. As the technology has improved, costs have dropped such that these papers are now within the current range of fine printing papers. There are still barriers to entry into the imaging arena, however, pertaining to stiffness, opacity, conductivity, and surface roughness. Stiffness tends to be the primary feature where synthetic papers compare poorly to cellulose containing media. P-172 Synthetic Paper Industry Report, pg. 3, Business Communications Co., Inc., Norwalk, Conn., March 2001. In order to meet cost requirements, the newly introduced synthetic papers (e.g., Japanese Patent 2000211008) typically are comprised of polyethylenes and polypropylenes. Due to the inherently lower elastic modulus of these materials, the stiffness for a sheet of any given comparable weight is at a significant disadvantage compared to a paper base of approximately the same weight. It is well known that stiffness of an imaging element is a function of the modulus of the various layers of the imaging element, the location of the various layers (particularly in terms of the distance from the bending axis) and the overall caliper of the imaging element. Improvements that can be made to the modulus of the various layers comprising the imaging element can increase the overall bending stiffness of the element thus, in turn, increasing its value as an imaging support.

U.S. Pat. No. 6,537,656 presents a foam core imaging member that has adhered to each side a flange sheet comprising extruded or stretched polyolefin. Although this element exhibits the required stiffness associated with that of an imaging element, there is a problem with this in that the surface roughness of the element, which is a function of the surface roughness of the foam core, is poor. The poor surface roughness is inherent to the foaming process wherein the rate of quenching, chill roller surface, blowing agent concentration, additional additives, and polymer matrix material all play a significant role in foam surface quality. Accordingly, it has limited application as an imaging base.

Organic additives that have the potential to enhance the modulus of oriented polyolefin film are known in the art. The composition of the organic additive, which is typically a hydrocarbon resin, must be such that it exhibits a higher glass transition temperature (Tg) than polypropylene. It must also be compatible with polypropylene. It is believed that the addition of the organic additive increases the Tg of the amorphous polypropylene, leading to a densification of the amorphous phase over time, which leads to increased stress transfer between crystalline regions (also called a pseudo network effect) that, in turn, leads to increasing stiffness. For example, Bossaert et al in U.S. Pat. No. 4,921,749 claims a polyolefin film comprising a base layer of 70% to 97% polypropylene and 30% to 3% hydrogenated resin. The addition of about 20% hydrogenated resin is shown to result in an increase in modulus of about 10-20%. Klosiewicz in U.S. Pat. No. 6,281,290 claims a process for producing a master batch for a polypropylene article (film, fiber, sheet, or bottle) comprising a mixture of polypropylene, high density polyethylene and hydrocarbon resin having a ring and ball softening point of at least 70° C. The addition of low levels of hydrocarbon resin and high density polyethylene (HDPE) are reported to increase the tensile modulus of extrusion cast oriented polypropylene films by 15% to 70%.

Traditional imaging elements derive a predominant fraction of their bending stiffness from the cellulose paper substrate and as such do not require the use of organic stiffening additives. However, in the case of non-cellulose core imaging elements, there is potentially a significant application of such technology if it is shown to be viable for polyolefin elements and for extrusion coating processes. C-S Liu in U.S. Pat. No. 4,365,044 discloses an extrusion-coatable polypropylene composition comprising a hydrogenated copolymer of vinyl toluene, alpha-methyl styrene, and low density polyethylene. Extrusion coatability at speeds up to about 275 m/minute, and good adhesion to cellulose substrates is claimed. However, such a composition is not suitable for use in an imaging element.

Opacity can also be a limiting factor for many of the available all synthetic materials. Usually these materials cannot provide a comparable opacity to cellulose bases unless excessive levels of fillers are used.

Coating on polymer films rather than cellulose paper has been known to improve several surface characteristics, such as “orange peel”. “Orange peel” arises primarily from the surface non-uniformity of the paper formation, this non-uniformity becomes more noticeable and therefore more objectionable the glossier the surface. As the resin coating layers become thinner. “orange peel” and the natural roughness of the cellulose paper fibers are more apt to become objectionable. While polymer films (including some synthetic papers with low Rₐ values) would offer advantages for an imaging media on the image side, the lack of roughness on the backside of these papers can cause tremendous transport problems throughout the manufacturing process.

In a non-imaging application in U.S. Patent Application Publication 2002/0015834 of Biddiscombe also discusses the use of biaxially oriented polymeric films having a core layer comprising a voided homopolymer with a density of not more than 0.70 g/cm³, and at least one substantially non-voided layer on each surface of the core layer. The disadvantage of this structure for an imaging element is that all layers are stretched biaxially, therefore limiting composition and functionality of those layers. This is the same disadvantage apparent for U.S. Pat. No. 6,153,367 where there is discussion of an integral biaxially oriented polyolefin polymer sheet with a lower layer having a matte surface. In this patent, “any suitable biaxially oriented polyolefin sheet may be used for the base of the invention. Microvoided biaxially oriented sheets are preferred and are conveniently manufactured by coextrusion of the core and surface layers, followed by biaxial orientation, whereby voids are formed around void-initiating material contained in the core layer.” As indicated, this sheet is also coextruded and all layers are stretched simultaneously, limiting composition and functionality of those layers. Microvoided supports tend not to be useful with pressure developed imaging elements because they are not dense enough. U.S. Pat. No. 5,916,727 describes a self-contained imaging element containing a first transparent support, an imaging composition, a layer of adhesive, and a second support which may or may not contain opacifying agent. The second support is preferably an opaque support such as polyethylene terephthalate (PET) containing an opacifying agent, paper or paper lined with film. The disadvantages associated with paper-based supports have already been discussed hereinabove. Opaque PET-based supports are very costly and give the imaging media a plastic-like feel.

A pressure developable imaging element is needed wherein the support is dense enough to provide good Dmax when the material is developed with pressure. It is also desired that the support contains a reduced amount of raw paper to become effectively recyclable and is optimized to meet stiffness, colorimetry, opacity, and cost requirements. Further, the support should provide a very smooth surface under the image, thereby aiding in gloss improvement and surface uniformity improvement.

### SUMMARY OF THE INVENTION

This invention provides a pressure developable imaging element comprising a support and an image forming unit comprising photosensitive microcapsules and a developer, wherein said support comprises a substrate comprising polyolefin or a copolymer thereof, wherein said substrate has a density of greater than 0.9 grams/cc. The support for use in the present invention is substantially free of paper fiber.

The imaging element of the invention provides excellent imaging layer Dmax because there is no cushioning effect from the support during pressure development. Further, the support is low cost and easy to utilize. The support utilized in the invention has high stiffness, excellent surface uniformity and smoothness, high opacity, humidity curl resistance, and resistance to cockle. The imaging support can also be effectively recycled.

### DETAILED DESCRIPTION OF THE INVENTION

The support utilized in the invention comprises a substrate comprising polyolefin or a copolymer thereof, wherein said substrate has a density of greater than 0.9 grams/cc and preferably greater than 1.0 grains/cc. Most preferably the substrate has a density of 1.1 grams/cc to 1.6 grams/cc. The term “substrate” refers to a freestanding film having a thickness of at least 4 mil, and preferably 6 mil (1 mil is equal to 25 μm.)

Suitable polyolefins include polypropylene, polyethylene, polymethylpentene, polystyrene, polybutylene, and mixtures thereof. Polyolefin copolymers, including copolymers of propylene and ethylene such as hexene, butene, and octene are also useful. The polyolefin is preferably polypropylene, polyethylene, polypropylene co-polymer derivatives, or polyethylene co-polymer derivatives. Most preferably the polyolefin is polypropylene or a polypropylene copolymer derivative, with polypropylene being preferred as it is low in cost and has desirable strength properties.

The polyolefin substrate may contain filler materials, but the fillers are primarily used for optical or smoothing properties or to enhance stiffness rather than for voiding, since voiding normally decreases density. Fillers used as opacifying and stiffening agents can be inorganic or organic. Some of the commonly used inorganic filler materials are talc, clays, calcium carbonate, magnesium carbonate, barium sulfate, mica, aluminum hydroxide (trihydrate), wollastonite, glass fibers and spheres, silica, various silicates, and carbon black.

Some of the organic fillers used are wood flour, jute fibers, sisal fibers, polyester fibers, and the like. The preferred fillers that also act as stiffening agents by enhancing the modulus are talc, mica, and calcium carbonate. Another key additive to the substrate compositions to enhance physical properties such as modulus and stiffness of the imaging element is a low molecular weight substantially amorphous resin or rosin additive. The low molecular weight resin or rosin additive, preferably hydrogenated, has a number average molecular weight below that of the polyolefin to which it is added. The additive resin or rosin may be natural or it may be synthetic. Examples of suitable resins are amorphous petroleum hydrocarbons, coal or petroleum derivatives, substituted hydrocarbons or hydrocarbon derivatives such as polyterpene resins, rosins, rosin derivatives, and styrene resins. These materials may be characterized using the Ring and Ball softening point test and typically have a softening temperature in the range from about 30° C. to about 200° C., and more typically in the range from about 70° C. to about 180° C. The additive resin must exhibit a higher glass transition temperature (Tg) than the matrix polymer and must be, at least to a limited extent, compatible with the matrix polymer. For example, if the matrix polymer is polypropylene, then the additive resin must have a higher glass transition temperature than polypropylene. It must also be compatible with polypropylene. Compatibility with the matrix polymer may be manipulated by reducing the average molecular weight of the resin additive or by functionalizing the resin additive. For example, the resin additive may be functionalized with a polar functional group for use with a polar matrix polymer. The resin additive is typically added from about 2% concentration by weight to about 50% concentration by weight. Preferably, it is added from about 10% concentration by weight to about 20% concentration by weight. At an addition level of less than 2%, there is little change in the desired modulus. At addition levels greater than about 50%, processability becomes a concern due to poor chill roll release. Examples of resin additives include, but are not limited to, master batched materials, for example, cyclopentadiene derivatives master batched with polypropylene such as PA®-609 made by Exxon Mobil, or pure monomer hydrocarbon resins master batched with a polyolefin such as Plastolyn® P2539 made by Eastman Chemical Co. Physical blends of hydrogenated hydrocarbon resins and polymer such as Res® P2567, partially hydrogenated aliphatic hydrocarbon resins such as Res® A2661, or fully hydrogenated aliphatic hydrocarbon resins such as the Regalite®® R1125 or Regalite® V3140, or hydrogenated pure aromatic resins such as Regalrez® 1139, or polyterpenes such as Piccolyte® C135. While some of the fillers may be organic, it is intended that paper fibers not be necessary as a filler to meet the imaging element stiffness requirements.

Preferably the support is opaque, and most preferably it is white. These properties may be provided by the polyolefin substrate or by the flange layers, if present, discussed below. They may also be provided by overcoat layers, such as polyethylene. More than one layer of the support may provide these properties. Optical properties, such as opacity and colorimetry, may be met by the appropriate use of filler materials, such as titanium dioxide and calcium carbonate, and colorants, dyes and/or optical brighteners or other additives known to those skilled in the art. High opacity imaging media is preferred by the consumer as it minimizes “show through” from one print to the next and also minimizes the “show through” from any backside logo or printing. Generally, the support for the imaging elements of the invention are white, possibly with a blue tint, as a slight blue is preferred to form a “preferred look” for whites in an image. In one embodiment the support, and/or individual layers thereof, has a high L*, preferably an L* greater than 92 and more preferably greater than 94 so that white objects in the final image, such as wedding dresses and snow, do not have a gray cast. An L* less than 99 is preferable since an L* greater than 99 is difficult and costly to achieve. Most preferably the support has the following values, L* of 92 to 99, a* of −1 to +1 and b* of −10 to 0. Any suitable white pigment may be incorporated in a layer of the support such as, for example, titanium dioxide zinc oxide, zinc sulfide, zirconium dioxide, white lead, lead sulfate, lead chloride, lead aluminate, lead phthalate, antimony trioxide, white bismuth, tin oxide, white manganese, white tungsten, calcium carbonate, barium sulfate, or alkaline metal silicates, such as talc, mica, and clays, and combinations thereof. The pigment is used in any form that is conveniently dispersed. The preferred pigment is titanium dioxide. In addition, suitable optical brightener may be employed in the polyolefin layer or other layers, including those described in Research Disclosure, Vol.308, December 1989, Publication 308119, Paragraph V, page 998.

Manufacture of the polyolefin substrate could be accomplished through blown film or cast extrusion processes. In one embodiment the layer is oriented either biaxially or uniaxially by stretching.

The suitable range in caliper of the polyolefin substrate is from 100 to 305 μm. The preferred caliper range is between 100 μm and 250 μm because of the preferred overall caliper range of the element, which lies between 125 μm and 400 μm. Below 125 μm consumers do not perceive “photo quality feel” and above 400 μm there is limited consumer perceived added value. In one embodiment the modulus of the polyolefin substrate is between and includes 30 MPa and 1000 MPa.

In one embodiment of the pressure developable imaging element of the invention the support further comprises at least one unoriented layer, hereinafter called a flange layer, comprising polyolefin or a copolymer thereof. While the purpose of the layer is mainly to stiffen the support it may provide other functions also, such as caliper, optical properties, adhesion, and smoothness. In a preferred embodiment the support comprises two unoriented flange layers, and the polyolefin substrate is sandwiched between the two unoriented flange layers, forming a polyolefin substrate core. The flange members may be extrusion or adhesive coated.

The unoriented flange layer(s) of the support can be made of the same types of polymeric materials as listed above for the polyolefin substrate. The support can be made with unoriented flange layers of the same composition as the polyolefin substrate or it can be made with unoriented layers of a different composition than the polyolefin substrate.

In a preferred melt extrusion coating embodiment of this invention, the flange layer or layers comprise high modulus extrusion-coatable polymer compositions such as high density polypropylene, polyethylene, polymethylpentene, polystyrene or polystyrene, their blends or their copolymers with other polymers such as low density polyethylene, branched polypropylene, which may improve their extrusion coatability. It may be necessary to use other additives for improved coatability, opacity, stiffness through modulus modification, and smoothness. Additives might also include such materials as antioxidants, slip agents, or lubricants, and light stabilizers. These additives are added to improve, among other things, the dispersibility of fillers and/or colorants, as well as the thermal and color stability during processing and the manufacturability and the longevity of the finished article. For example, the coating may contain antioxidants such as 4,4′-butylidene-bis(6-tert-butyl-meta-cresol), di-lauryl-3,3′-thiopropionate, N-butylated-p-aminophenol, 2,6-di-tert-butyl-p-cresol. 2,2-di-tert-butyl-4-methyl-phenol, N,N-disalicylidene-1,2-diaminopropane, tetra(2,4-tert-butylphenyl)-4,4′-diphenyl diphosphonite, octadecyl 3-(3′,5′-di-tert-butyl-4′-hydroxyphenyl propionate), combinations of the above, and the like, heat stabilizers, such as higher aliphatic acid metal salts such as magnesium stearate, calcium stearate, zinc stearate, aluminum stearate, calcium palmitate, zirconium octylate, sodium laurate, and salts of benzoic acid such as sodium benzoate, calcium benzoate, magnesium benzoate and zinc benzoate, light stabilizers such as hindered amine light stabilizers (HALS), of which a preferred example is poly{[6-[(1.1,3,3-tetramethylbutylamino}-1,3,5-triazine-4-piperidinyl)-imino]-1,6-hexanediyl[{2,2,6,6-tetramethyl-4-piperdinyl)imino]}(Chimassorb® 944 LD/FL).

Optical properties, such as opacity and colorimetry, may be met by the appropriate use of filler materials as described above. Preferably the unorienited flange layer comprises an organic or inorganic stiffening agent, more preferably an inorganic stiffening agent. Fillers used as stiffening agents can be inorganic or organic. Some of the commonly used inorganic filler materials are talc, clays, calcium carbonate, magnesium carbonate, barium sulfate, mica, aluminum hydroxide (trihydrate), wollastonite, glass fibers and spheres, silica, various silicates, and carbon black. Some of the organic fillers used are wood flour, jute fibers, sisal fibers, polyester fibers, and the like. The preferred fillers that also act as stiffening agents by enhancing the modulus are inorganic metal silicate, carbonate, or glass fiber, particularly talc, mica, and calcium carbonate. Another key additive to extrusion coatable compositions to enhance physical properties such as modulus and stiffness of the imaging element is a low molecular weight substantially amorphous resin or rosin additive. The low molecular weight resin or rosin additive, preferably hydrogenated, has a number average molecular weight below that of the polyolefin to which it is added. The additive resin or rosin may be natural or it may be synthetic. Examples of suitable resins are amorphous petroleum hydrocarbons, coal or petroleum derivatives, substituted hydrocarbons or hydrocarbon derivatives such as polyterpene resins, rosins, rosin derivatives, and styrene resins. These materials may be characterized using the Ring and Ball softening point test and typically have a softening temperature in the range from about 30° C. to about 200° C., and more typically in the range from about 70° C. to about 180° C. The additive resin must exhibit a higher glass transition temperature (Tg) than the matrix polymer and must be, at least to a limited extent, compatible with the matrix polymer. For example, if the matrix polymer is polypropylene, then the additive resin must have a higher glass transition temperature than polypropylene. It must also be compatible with polypropylene. Compatibility with the matrix polymer may be manipulated by reducing the average molecular weight of the resin additive or by functionalizing the resin additive. For example, the resin additive may be functionalized with a polar functional group for use with a polar matrix polymer. The resin additive is typically added from about 2% concentration by weight to about 50% concentration by weight. Preferably, it is added from about 10% concentration by weight to about 20% concentration by weight. At an addition level of less than 2%, there is little change in the desired modulus. At addition levels greater than about 50%, processability becomes a concern due to poor chill roll release. Examples of resin additives include, but are not limited to, master batched materials, for example., cyclopentadiene derivatives master batched with polypropylene such as PA®-609 made by Exxon Mobil, or pure monomer hydrocarbon resins master batched with a polyolefin such as Plastolyn® P2539 made by Eastman Chemical Co. Physical blends of hydrogenated hydrocarbon resins and polymer such as Res® P2567, partially hydrogenated aliphatic hydrocarbon resins such as Res® A2661, or fully hydrogenated aliphatic hydrocarbon resins such as the Regalite® R1125 or Regalite® V3140, or hydrogenated pure aromatic resins such as Regalrez® 1139, or polyterpenes such as Piccolyte® C135. While some of the fillers may be organic, it is intended that paper fibers not be necessary as a filler to meet the imaging element stiffness requirements.

Imaging elements are typically constrained by consumer preference and present imaging equipment restrictions. A preferred stiffness range is between approximately 50 mN and 300 mN. In the design of the element of the invention, there exists a relationship between stiffness of the imaging element and the caliper and modulus of the polyolefin substrate and modulus of the flange sheets, i.e. for a given polyolefin substrate core thickness, the stiffness of the element can be altered by changing the caliper of the flange elements and/or changing the modulus of the flange elements and/or changing the modulus of the polyolefin substrate core.

If the target overall stiffness and caliper of the imaging element are specified then for a given core thickness and core material, the target caliper and modulus of the flange elements are implicitly constrained. Conversely, given a target stiffness and caliper of the imaging element for a given caliper and modulus of the flange sheets, the core thickness and core modulus are implicitly constrained.

Preferred ranges of flange caliper, and polyolefin substrate core and flange modulus follow. The caliper of the flange layers of the invention ranges between 10 μm and 175 μm, the modulus of the polyolefin substrate core of the invention ranges between 30 MPa and 1000 MPa, and the modulus of the flange sheets of the invention ranges from 700 MPa to 10500 MPa. In each case, the above range is preferred because of (a) consumer preference, (b) manufacturability, and (c) materials selection. It is noted that the final choice of flange and core materials, modulus, and caliper will be a subject of the target overall element stiffness and caliper and density. The selection of core material, the density and the use of any additives/treatments determine the core modulus. The selection of flange materials and treatments (for example, the use of inorganic fillers such as talc for polymeric flange materials) determines the flange modulus.

In addition to the stiffness and caliper, an imaging element needs to meet constraints in surface smoothness and optical properties such as opacity and colorimetry. Surface smoothness characteristics may be met during flange layer manufacturing operations such as during the manufacture of oriented polymers like oriented polystyrene. For the element of this invention, long wavelength surface roughness or orange peel is of interest. For the irregular surface profile of the element of this invention, a 0.95 cm diameter probe is used to measure the surface roughness of the paper and, thus, bridges all fine roughness detail. The preferred surface roughness of the element is between 0.05 and 0.44 μm. At surface roughness greater than 0.44 μm, little improvement in image quality or “orange peel” is observed when compared to current photographic papers. A polymer sheet surface roughness less than 0.05 μm is difficult to manufacture and costly. Because the image side surface and transport surfaces are relatively independent of each other, each surface may be designed to fit the respective need. Alternatively, the surface requirements may be met by extrusion coating additional layer(s) of polymers such as polyethylene onto the flange layers in contact with a textured chill-roll or similar technique known by those skilled in the art. The nonimage side should have a surface roughness average (Rₐ) greater than 0.30 μm to ensure efficient transport through the photofinishing equipment. At surface roughness less that 0.30 μm transport through the photofinishing equipment becomes less efficient. At surface roughness greater than 2.54 μm, the surface would become too rough causing transport problems in photofinishing equipment.

The support utilized in the invention, while described as having preferably at least three layers, a high density polyolefin substrate core and a flange layer on each side, may also be provided with additional layers that may serve to change the properties of the oriented sheet. The oriented extrusion could be carried out with as many as 10 layers if desired to achieve some particular desired property. These elements may be coated or treated after the coextrusion and orienting process or between casting and full orientation with any number of coatings which may be used to improve the properties of the sheets including printability, to provide a vapor barrier, to make them heat sealable, or to improve the adhesion to the support or to the photosensitive layers. Examples of this would be acrylic coatings for printability, coating polyvinylidene chloride for heat seal properties. Further examples include flame, plasma, or corona discharge treatment to improve printability or adhesion. The unoriented structure may also have more than one layer, other layers may be added to provide feature. In one embodiment the flange layer is treated to adhere to gelatin.

Unoriented “flange” layers could be added through adhesive or extrusion lamination. In a preferred extrusion coating embodiment of this invention, the flange members are coated onto the high density substrate core through an extrusion coating operation in contact with a textured chill-roll or similar technique known by those skilled in the art.

In a preferred embodiment of the manufacturing method, the manufacturing process would be reduced to one manufacturing process whereby the polyolefin substrate core would be cast extruded, biaxially stretched, and extrusion coated with the previously discussed flange layers. This would allow waste material to be easily recycled into the core. This would offer the consumer a “greener” and environmental friendlier product as less manufacturing waste would be discarded into landfills. This would also assist in reducing product inventories and would allow sizing of the manufacturing facility to fit the area need. It would also minimize inefficient width uses of base and coating machines.

A typical imaging element also requires an auxiliary or antistatic layer for charge dissipation during high speed transport in manufacturing, finishing or post-processing applications. The problem of controlling static charge is well known in the field of photography and imaging. The accumulation of charge surfaces leads to the attraction of dirt, which can produce physical defects. The discharge of accumulated charge during or after the application of a light sensitive imaging emulsion layer(s) can produce irregular fog patterns or “static marks” in the emulsion. The static problems have been aggravated by increase in the sensitivity of new emulsions, increase in coating machine speeds, and increase in post-coating drying efficiency. The charge generated during the coating process may accumulate during winding and unwinding operations, during transport through the coating machines and during finishing operations such as slitting and spooling.

It is generally known that electrostatic charge can be dissipated effectively by incorporating one or more electrically conductive “antistatic” layers into the imaging element. Antistatic layers can be applied to one or to both sides of the imaging member as subbing layers either beneath or on the side opposite to the imaging layer. An antistatic layer can be applied as an outer coated layer either over the image forming layer or on the side of the imaging element base opposite to the image forming layer or both. For some applications, the antistatic agent can be incorporated into the image forming layer. Alternatively, the antistatic agent can be directly incorporated into the polyolefin substrate core or the unoriented flange layers. Many antistatic agents are known in the art. Particularly suitable antistatic agents are compounds such as dodecylbenzenesulfonate sodium salt, octylsulfonate potassium salt, oligostyrenesulfonate sodium salt and laurylsulfosuccinate sodium salt, and the like.

The imaging element of the invention comprises a support and a light sensitive imaging forming unit comprising microcapsules and a developer.

In one embodiment it also comprises an inner protective layer overlaying the image forming unit, i.e. on the opposite side of the image forming unit from the support and an outer protective layer overlaying the inner protective layer. The outermost protective layer protects the imaging element against scratches, pressure marks, cinch marks, and water resistance. The inner protective overcoat layer protects the imaging elements from damage by ultraviolet rays. The inner protective layer also act as a cushioning layer to protect the image element from damage by handling. The two-layer format also provides significant gloss improvement over a single protective layer.

It is preferred that the outer protective overcoat layer has a modulus greater than the modulus of the inner protective layer. i.e., that the inner layer be softer than the outer layer. Preferably the inner protective overcoat layer has a Young's modulus less than 3 Gpa, and the outer protective layer has a Young's modulus greater than 3 Gpa. The Young's modulus ratio of the outer protective layer to inner protective layer is preferably greater than 1.2, and more preferably greater than 1.5. The thickness of the outer protective layer ranges from 0.1 to 6 μm, and preferably from 0.3 to 4 μm, and more preferably from 0.5 to 3 μm. The thickness of the inner protective layer is greater than 0.5 μm, and preferably greater than 1 μm, and more preferably from 2 to 15 μm. The ratio of inner protective layer thickness to the outer protective layer thickness is greater than 1.

The inner protective overcoat layer preferably comprises a hydrophilic colloid. The hydrophilic colloid useful for the present invention includes both synthetic and natural water soluble polymers. Preferably the hydrophilic polymers suitable for use in the present invention further comprise either a chemical moiety capable of capable of forming a covalent chemical bond with a cross-linker. Naturally occurring substances include proteins, protein derivatives, cellulose derivatives (e.g., cellulose esters), polysaccharides, casein, and the like, and synthetic water permeable colloids include poly(vinyl lactams), acrylamide polymers, poly(vinyl alcohol) and its derivatives, hydrolyzed polyvinyl acetates, polymers of alkyl and sulfoalkyl acrylates and methacrylates, polyamides, polyvinyl pyridine, acrylic acid polymers, maleic anhydride copolymers, polyalkylene oxide, methacrylamide copolymers, polyvinyl oxazolidinones, maleic acid copolymers, vinyl amine copolymers, methacrylic acid copolymers, acryloyloxyalkyl sulfonic acid copolymers., vinyl imidazole copolymers, vinyl sulfide copolymers, homopolymer or copolymers containing styrene sulfonic acid, and the like. Gelatin is the most preferred hydrophilic colloid for the present invention.

The inner protective overcoat layer may further comprise a water dispersible resin. Resins which can be used in the protective coating of the present invention include those having film-forming properties. When formed into a film by drying or curing, the resin should be essentially transparent and remain transparent over a broad temperature range without clouding or yellowing. The resin film should also impart scratch resistance, water resistance, gloss and durability to the protective coating. Examples of water-dispersible resins include acrylic latex (e.g., acrylic ester, modified acrylic ester, acrylic ester copolymer, modified acrylic ester copolymer) and other polymer latices (e.g., styrene-butadiene copolymer, styrene-maleic anhydride copolymer, butadiene-methacrylate copolymer, vinylacetate-vinyl chloride-ethylene copolymer, vinylidene chloride-acrylonitrile copolymer, etc.). In one embodiment, the resin used in the protective coating is an acrylic latex. Examples of acrylic latices, include but are not limited to, acrylic esters, modified acrylic esters, acrylic ester co-polymers, and modified acrylic ester copolymers. In another embodiment of the invention, the resin used in the protective overcoat is a water dispersible polyurethane, or an acrylic-polyurethane hybrid.

The outer protective overcoat layer may comprise the same hydrophilic colloids and water dispersible resins as described above for the inner protective layer. Cross-linking agents may be incorporated into the inner and outer protective coating composition, depending on the types of polymer used, to ensure that the protective coating provides the desired properties, namely water resistance, scratch resistance, and gloss. Examples of preferred cross-linking agents used in the protective coating include, but are not limited to, polyvalent aldehyde compounds such as glyoxal, glutaraldehyde, and derivatives of those compounds which retain free aldehyde groups. Glyoxal is the preferred polyaldehyde. Other cross-linking agents useful in the present invention include di-isocyanate compounds, epoxy compounds, bis-ethyleneimine compounds, di-vinyl compounds (e.g., divinylbenzene), methacrylic (or acrylic) ester of polyhydric alcohol (e.g., TMPTA), allylglycidyl ether, di-epoxide of polyhydric alcohol, methacrylic anhydride, N-methylolacrylamide, organic peroxide, di-amine compounds, bis-2-oxazoline compounds, polymers having 2-oxazoline group and polymer having carbodiimide group. The cross-linking agent is typically present in an amount from about 2% to 20%, and preferably from about 4% to 10%, based on total solids content of the protective coating.

The inner protective layer and the outer protective layer may further include other additional components such as surfactants, UV absorbing compounds, light stabilizers, pigments, matting agents, fillers, etc. Inclusion of surfactants as wetting agents allows the aqueous coating solution to spread uniformly across the photosensitive layer's surface and produce a smooth coating. Generally, the amount of wetting agent in the coating solution should be from about 1% to about 10% by weight of the coating solution, more preferably from about 4% to about 8%. Examples of wetting agents include diakyl sulfosuccinate sodium salt and anion fluoroalkyl type surfactants. These surfactants are commercially available from Kao Corp. (PELEX OTP) and Dainippon Ink Chemicals, Inc. (Megafac F140NK), respectively.

Preferably the UV absorbing compounds are in the inner protective layer. Such compounds improve the light resistance and stability of the image media. The types of ultraviolet ray absorbers which can be used for the practice of the present invention are not particularly limited provided their absorption maximum wavelengths fall within the range of 300 to 400 nm, and they have no harmful effect on the imaging properties of the element. Such UV dyes include ultraviolet absorbers of the thiazolidone type, the benzotriazole type, the cinnamic acid ester type, the benzophenone type, and the aminobutadiene type and have been described in detail in, for example, U.S. Pat. Nos. 1,023,859; 2,685,512; 2,739,888; 2,748,021; 3,004,896; 3,052,636; 3,215,530; 3,253,921; 3,533,794; 3,692,525; 3,705,805; 3,707,375; 3,738,837; and 3,754,919; and British Patent 1,321,355. Preferably the UV absorber is a benzotriazole compound and, in particular, a high molecular weight benzotriazole emulsion. A specific material this type is ULS-1383 MG available from Ipposha Oil. The amount of the ultraviolet absorbing compound is not limited specifically: it is desirable to adjust the amount preferably to 5% to 30% based on total solids content of the protective coating.

The outer protective layer may further comprise a stiff filler that has a modulus greater than 10 Gpa. Representative stiff fillers include colloidal silica, colloidal tin oxide, colloidal titanium dioxide, mica, clays, doped-metal oxides, metal oxides containing oxygen deficiencies, metal antimonates, conductive nitrides, carbides, or borides, for example, TiO₂, SnO₂, Al₂O₂, ZrO₃, In₂O₂, MgO, ZnSb₂O₂, InSbO₂, TiB₂, ZrB₂, NbB₂, TaB₂, TaB₂, CrB₂, MoB, WB LaB₆, ZrN, TiN, TiC, and WC. Preferably, the stiff filler has a refractive index less than or equal to 2.1, and most preferably less than or equal to 1.6. It is important to limit the refractive index of the filler in order to provide good transparency of the layer. Preferably the outer protective layer comprise greater than 10%, more preferably than 15% stiff filler. It is important to limit the refractive index of the filler in order to provide good transparency of the layer. The filler also has a particle size less than or equal to 500 nm, and preferably, less than 100 nm.

The outer protective layer may further comprise a pigment to improve handling and to prevent blocking. The pigment is defined to have a particle size of greater than 0.5 μm. Examples of the pigment may include inorganic pigments such as calcium carbonate, zinc oxide, titanium dioxide, silicone dioxide, aluminum hydroxide, barium sulfate, zinc sulfate, talc, kaolin, clay and colloidal silica, and organic pigments such as styrene microballs, nylon powder, polyethylene powder, urea-formaldehyde resin filler, and raw starch particles.

The outer protective layer may further comprise a lubricant. Examples of lubricants include (1) silicone based materials disclosed, for example, in U.S. Pat. Nos. 3,489,567; 3,080,317; 3,042,522; 4,004,927; and 4,047,958: and in British Patent Nos. 955,061 and 1,143,118; (2) higher fatty acids and derivatives, higher alcohols and derivatives, metal salts of higher fatty acids, higher fatty acid esters, higher fatty acid amides, polyhydric alcohol esters of higher fatty acids, etc., disclosed in U.S. Pat. Nos. 2,454,043; 2,732,305; 2,976,148; 3,206,311; 3,933,516; 2,588,765; 3,121,060; 3,502,473; 3,042,222; and 4,427,964; in British Patent Nos. 1,263,722; 1,198.387; 1,430,997; 1,466,304; 1,320,757; 1,320,565; and 1,320,756; and in German Patent Nos. 1,284,295 and 1,284,294; (3) liquid paraffin and paraffin or wax like materials such as carnauba wax, natural and synthetic waxes, petroleum waxes, mineral waxes, and the like; (4) perfluoro- or fluoro- or fluorochloro-containing materials, which include poly(tetrafluoroethlyene), poly(trifluorochloroethylene), poly(vinylidene fluoride, poly(trifluorochloroethylene-co-vinyl chloride), poly(meth)acrylates or poly(meth)acrylamides containing perfluoroalkyl side groups, and the like. Lubricants useful in the present invention are described in further detail in Research Disclosure No.308, published December 1989, page 1006.

The imaging element of the invention may further comprise at least one non-imaging layer comprising a hydrophilic colloid located between the support and the imaging unit. Examples of suitable hydrophilic colloids include both synthetic and natural water soluble polymers. Preferably the hydrophilic polymers suitable for use in the present invention further comprise either a chemical moiety capable of capable of forming a covalent chemical bond with a cross-linker. Naturally occurring substances include proteins, protein derivatives, cellulose derivatives (e.g., cellulose esters), polysaccharides, casein, and the like, and synthetic water permeable colloids include poly(vinyl lactams), acrylamide polymers, poly(vinyl alcohol) and its derivatives, hydrolyzed polyvinyl acetates, polymers of alkyl and sulfoalkyl acrylates and methacrylates, polyamides, polyvinyl pyridine, acrylic acid polymers, maleic anhydride copolymers, polyalkylene oxide, methacrylamide copolymers, polyvinyl oxazolidinones, maleic acid copolymers, vinyl amine copolymers, methacrylic acid copolymers, acryloyloxyalkyl sulfonic acid copolymers, vinyl imidazole copolymers, vinyl sulfide copolymers, homopolymer or copolymers containing styrene sulfonic acid, and the like. Gelatin is the most preferred hydrophilic colloid for the present invention.

The non-imaging layer may further comprise a latex or a water dispersible resin. Resins which can be used in the non-imaging layer of the present invention include those having film-forming properties. When formed into a film by drying or curing, the resin should be essentially transparent and remain transparent over a broad temperature range without clouding or yellowing.

Examples of water-dispersible resins include acrylic latex (e.g., acrylic ester, modified acrylic ester, acrylic ester copolymer, modified acrylic ester copolymer) and other polymer latices (e.g., styrene-butadiene copolymer, styrene-maleic anhydride copolymer, butadiene-methacrylate copolymer, vinylacetate-vinyl chloride-ethylene copolymer, vinylidene chloride-acrylonitrile copolymer, etc.). In one embodiment, the binder used in the non-imaging layer is an acrylic latex. Examples of acrylic latices, include but are not limited to, acrylic esters, modified acrylic esters, acrylic ester co-polymers, and modified acrylic ester copolymers. In another embodiment of the invention, the binder used in the non-imaging layer is a water dispersible polyurethane, or an acrylic-polyurethane hybrid. In one embodiment the non-imaging layer may comprise a cross-linker as described above for the protective layers.

If necessary, an antihalation layer may be provided on the surface of the support to be used. The imaging element may also comprise an antistatic layer, preferably on the back of the support, i.e., the opposite side of the support from the imaging unit. Further, a sliding layer, a curl-preventive layer, an adhesive layer, or the like may be provided on the back of the support to be used. Further, if necessary, an adhesive layer may be provided between a support and the light sensitive and pressure developable image forming unit such that the support is used as a peel paper to thereby provide an aspect having a seal.

When an antihalation layer is provided between a support and the light sensitive and pressure-developable image forming unit or alternatively, on the support surface facing the side having image forming unit in the case of a transparent support, the antihalation layer may be one that can be bleached by irradiation with light or by the application of heat.

For the preparation of a layer that can be bleached by irradiation with light, for example, a combination of the organic dye and organic borate compound described previously can be used. For the preparation of a layer that can be bleached by heat, for example, a composition in which the heat generates a base or nucleophile capable of bleaching the organic dye that is present can be utilized.

The imaging element of the present invention can be prepared by a process comprising the steps of preparing a coating liquid for forming a light sensitive and pressure developable image forming unit or the separate imaging layers, a coating liquid for forming protective layers or intermediate layer by, for example, dissolving the respective constituent components in solvents, applying the coating liquids successively onto a desired support, and drying the coating layers. Examples of the solvent that can be used for the preparation of the coating liquids include water; alcohols such as methanol, ethanol, n-propanol, isopropanol, n-butanol, sec-butanol, methyl cellosolve, and 1-methoxy-2-propanol; halogen-based solvents such as methylene chloride and ethylene chloride; ketones such as acetone, cyclohexanone, and methyl ethyl ketone; esters such as methyl cellosolve acetate, ethyl acetate, and methyl acetate; toluene; xylene; and a mixture of two or more thereof. Among these solvents, water is particularly preferable.

When applying the coating liquid for forming an image forming unit or imaging layer onto the support, a blade coater, a rod coater, a knife coater, a roll-doctor coater, a reverse roll coater, a transfer roll coater, a gravure coater, a kiss roll coater, a curtain coater, an extrusion coater, etc. can be used. The application can be carried out using the coating method described in Research Disclosure, Vol. 200 (1980, December, Item 20036 XV). The thickness of the image forming unit is preferably in the range of 0.1 to 50 μm, more preferably in the range of 5 to 35 μm and most preferably in the range of 10 to 30 μm.

The imaging element of the present invention comprises a support and an image forming unit above the support. The element is a light sensitive and pressure developable type imaging element comprising a support having at least one light sensitive and pressure developable image forming unit provided thereon.

The light sensitive and pressure developable image forming unit provided thereon includes light and pressure-response microcapsules enclosing a color-forming component A, a polymerizable compound, and a photopolymerization initiator. Outside the microcapsules is a substantially colorless compound E (developer) designed to react with the color-forming component A to develop a color. In the light sensitive and pressure developable imaging element exposure to light according to a desired image causes the polymerizable compound (D) present inside the microcapsules to harden the microcapsule interior by a polymerization reaction due to the radical generated from the photopolymerization initiator upon exposure so that a latent image in a desired shape is formed. That is, in the exposed portions, the color-forming reaction with the compound E present outside the microcapsules is inhibited. Next, when pressure is applied to the imaging element, the microcapsules which have not hardened (the unexposed microcapsules) are broken and the compound E present in the unexposed portions moves within the imaging element and reacts with the color-forming component A present inside the microcapsules to develop a color. Accordingly, the light sensitive and pressure developable image-imaging element (c) is a positive-type, light sensitive and pressure developable imaging element in which the image formation is performed such that color formation is not made in exposed portions but color formation is made in the unexposed portions that do not harden.

The image forming unit of the element may comprise one layer or more than one layer. The microcapsules and the developer may be in the same layer or in different layers. Preferably they are in the same layer. Microcapsules which are sensitive to different wavelengths of the spectrum may be in the same layer or in different layers. Preferably they are in the same layer.

The color-forming component A useful for the practice of the invention includes an electron-donating, colorless dye such that the dye reacts with a developer (i.e., compound E) to develop a color. Specific examples of these color-forming components include those described in Chemistry and Applications of Leuco Dye, Edited by Ramaiah Muthyala, Plenum Publishing Corporation, 1997. Representative examples of such color formers include substantially colorless compounds having in their partial skeleton a lactone, a lactam, a sultone, a spiropyran, an ester or an amido structure. More specifically, examples include triarylmethane compounds, bisphenylmethane compounds, xanthene compounds, thiazine compounds, and spiropyran compounds. Typical examples of the color formers include Crystal Violet lactone, benzoyl leuco methylene blue, Malachite Green Lactone, p-nitrobenzoyl leuco methylene blue, 3-dialkylamino-7-dialkylamino-fluoran, 3-methyl-2,2′-spirobi(benzo-f-chrome), 3,3-bis(p-dimethylaminophenyl)phthalide, 3-(p-dimethylaminophenyl)-3-(1,2 dimethylindole-3-yl)phthalide, 3-(p-dimethylaminophenyl)-3-(2-methylindole-3-yl)phthalide, 3-(p-dimethyl aminophenyl)-3-(2-phenylindole-3-yl)phthalide, 3,3-bis(1,2-dimethylindole-3-yl)-5-dimethylaminophthalide, 3,3-bis-(1,2-dimethylindole-3-yl)6-dimethylaminophthalide, 3,3-bis-(9-ethylcarbazole-3-yl)-5-dimethylaminophthalide, 3,3-bix(2-phenylindole-3-yl)-5-dimethylaminophthalide, 3-p-dimethyl aminophenyl-3-methylpyrrol e-2-yl)-6-dimethylaminophthalide, 4,4′-bis-dimethylaminobenzhydrin benzyl ether, N-halophenyl leuco Auramine, N-2,4,5-trichlorophenyl leuco Auramine, Rhodamine-B-anilinolactam, Thodamine-(p-nitroanilino)lactam, Rhodamine-B-(p-chloroanilino)lactam, 3-dimethylamino-6-methoxyfluoran, 3-diethylamino-7-methoxyfluoran, 3-diethylamino-7-chloro-6-methylfluoroan, 3-diethylamino-6-methyl-7-anilinofluoran, 3-diethylamino-7-(acetylmethylamino)fluoran, 3-diethylamino-7-(dibenzylamino)fluoran, 3-diethylamino-7-(methylbenzylamino)fluoran, 3-diethylamino-7-(chloroethylmethylamino)fluoran, 3-diethylamino-7-(diethylamino)fluoran, 3-methyl-spiro-dinaphthopyran, 3,3′-dichloro-spiro-dinaphthopyran, 3-benzyl-spiro-dinaphthopyran, 3-methyl-naphtho-(3-methoxybenzo)-spiropyran, 3-propyl-spirodibenzoidipyran, etc. Mixtures of these color precursors can be used if desired. Also useful in the present invention are the fluoran color formers disclosed in U.S. Pat. No. 3,920,510 which is incorporated by reference. In addition to the foregoing dye precursors, fluoran compounds such as disclosed in U.S. Pat. No. 3,920,510 can be used. In addition, organic compounds capable of reacting with heavy metal salts to give colored metal complexes, chelates or salts can be adapted for use in the present invention.

The substantially colorless compound E, which reacts with the color-forming component A to develop a color, may or may not have a polymerizable group. If compound E is a polymerizable developer, it has in the molecule a polymerizable group and a site that reacts with the color-forming component A to develop a color. The substantially colorless compound E may be any compound, such as electron-accepting compound having a polymerizable group, or a coupler compound having a polymerizable group, which has the two functions, i.e., developing a color by reacting with the color-forming component A and hardening by photopolymerization.

A substantially colorless compound E (developer), which has no polymerizable group and reacts with the color-forming component A to develop a color, can also be used. When compound E has no polymerizable group and it is necessary to impart a function of hardening the film by photopolymerization to the image forming layer, it needs to be used together with the photopolymerization composition comprising a compound D having a polymerizable group. The compound E can be any electron-accepting compound having no polymerizable group and that develops a color by reacting with the color-forming components A. Examples of compound E are clay minerals such as acid clay, active clay, attapulgite, etc.; organic acids such as tannic acid, gallic acid, propyl gallate, etc.; acid polymers such as phenol-formaldehyde resins, phenol acetylene condensation resins, condensates between an organic carboxylic acid having at least one hydroxy group and formaldehyde, etc.; metal salts of aromatic carboxylic acids or derivatives thereof such as zinc salicylate, tin salicylate, zinc 2-hydroxy napththoate, zinc 3,5 di-tert butyl salicylate, zinc 3,5-di-(a-methylbenzyl)salicylate, oil soluble metals salts or phenol-formaldehyde novolak resins (e.g., see U.S. Pat. Nos. 3,672,935 and 3,732,120) such as zinc modified oil soluble phenol-formaldehyde resin as disclosed in U.S. Pat. No. 3,732,120, zinc carbonate, etc., and mixtures thereof.

Compound D, having at least one polymerizable group, is an addition polymerizable compound selected from among the compounds having at least one, preferably two or more, ethylenically unsaturated bond at terminals. Such compounds are well known in the industry and they can be used in the present invention with no particular limitation. Such compounds have, for example, the chemical form of a monomer, a prepolymer, i.e. a dimer, a trimer, and an oligomer or a mixture and a copolymer of them. As examples of monomers and copolymers thereof, unsaturated carboxylic acids (e.g., acrylic acid, methacrylic acid, itaconic acid, crotonic acid, isocrotonic acid, maleic acid, etc.), and esters and amides thereof can be exemplified, and preferably esters of unsaturated carboxylic acids and aliphatic polyhydric alcohol compounds, and amides of unsaturated carboxylic acids and aliphatic polyhydric amine compounds are used. In addition, the addition reaction products of unsaturated carboxylic esters and amides having a nucleophilic substituent such as a hydroxyl group, an amino group and a mercapto group with monofunctional or polyfunctional isocyanates and epoxies, and the dehydration condensation reaction products of these compounds with monofunctional or polyfunctional carboxylic acids are also preferably used. The addition reaction products of unsaturated carboxylic esters and amides having electrophilic substituents such as an isocyanato group and an epoxy group with monofunctional or polyfunctional alcohols, amines and thiols, and the substitution reaction products of unsaturated carboxylic esters and amides having releasable substituents such as a halogen group and a tosyloxy group with monofunctional or polyfunctional alcohols, amines and thiols are also preferably used. As another example, it is also possible to use compounds replaced with unsaturated phosphonic acid, styrene, vinyl ether, etc., in place of the above-unsaturated carboxylic acids.

Specific examples of ester monomers of aliphatic polyhydric alcohol compounds and unsaturated carboxylic acids include, as acrylates, ethylene glycol diacrylate, triethylene glycol diacrylate. 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl) ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, polyester acrylate oligomer, etc. As methacrylates, examples include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, and bis[p-(3-methacryloxy-2-hydroxy-propoxy)phenyl]dimethylmethane, bis[p-(methacryloxyethoxy)-phenyl]dimethylmethane. As itaconates, examples include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate. As crotonates, examples include ethylene glycol dicrotonate, tetramethylene glycol dicrotonate, pentaerythritol dicrotonate, and sorbitol tetradicrotonate. As isocrotonates, examples include ethylene glycol diisocrotonate, pentaerythritol diisocrotonate, and sorbitol tetraisocrotonate. As maleates, examples include ethylene glycol dimaleate, triethylene glycol dimaleate, pentaerythritol dimaleate, and sorbitol tetramaleate. Further, the mixtures of the above-described ester monomers-can also be used. Further, specific examples of amide monomers of aliphatic polyhydric amine compounds and unsaturated carboxylic acids include methylenebis-acrylamide, methylenebis-methacrylamide, 1,6-hexamethylenebis-acrylamide, 1,6-hexamethylenebis-methacrylamide, diethylenetriaminetris-acrylamide, xylylenebis-acrylamide, and xylylenebis-methacrylamide.

Further, urethane-based addition polymerizable compounds which are obtained by the addition reaction of an isocyanate and a hydroxyl group are also preferably used in the present invention. A specific example is a vinyl urethane compound having two or more polymerizable vinyl groups in one molecule, which is obtained by the addition of a vinyl monomer having a hydroxyl group represented by the following formula (V) to a polyisocyanate compound having two or more isocyanate groups in one molecule.
CH₂═C(R)COOCH₂CH(R′)OH
wherein R and R′ each represents H or CH₃.

Other examples include polyfunctional acrylates and methacrylates, such as polyester acrylates, and epoxy acrylates obtained by reacting epoxy resins with (meth)acrylic acids. Moreover, photo-curable monomers and oligomers listed in Sartomer Product Catalog by Sartomer Company, Inc. (1999) can be used as well.

The details in usage of the addition polymerizable compound, e.g., what structure is to be used, whether the compound is to be used alone or in combination, or what an amount is to be used, can be optionally set up according to the final design of the characteristics of the photosensitive material. For example, the conditions are selected from the following viewpoint: For the photosensitive speed, a structure containing many unsaturated groups per molecule is preferred and in many cases bifunctional or more functional groups are preferred. For increasing the strength of an image part, i.e., a cured film, trifunctional or more functional groups are preferred. It is effective to use different functional numbers and different polymerizable groups (e.g., acrylate, methacrylate, styrene compounds, vinyl ether compounds) in combination to control both photosensitivity and strength. Compounds having a large molecular weight or compounds having high hydrophobicity are excellent in photosensitive speed and film strength, but may not be preferred from the point of development speed and precipitation in a developing solution. The selection and usage of the addition polymerizable compound are important factors for compatibility with other components (e.g., a binder polymer, an initiator, a colorant, etc.) in the photopolymerization composition and for dispersibility. For example, sometimes compatibility can be improved by using a low purity compound or two or more compounds in combination. Further, it is also possible to select a compound having specific structure for the purpose of improving the adhesion property of a support and an overcoat layer. Concerning the compounding ratio of the addition polymerizable compound in a photopolymerization composition, the higher the amount, the higher the sensitivity. But, too large an amount sometimes results in disadvantageous phase separation, problems in the manufacturing process due to the stickiness of the photopolymerization composition (e.g., manufacturing failure resulting from the transfer and adhesion of the photosensitive material components), and precipitation from a developing solution. The addition polymerizable compound may be used alone or in combination of two or more. In addition, appropriate structure, compounding ratio and addition amount of the addition polymerizable compound can be arbitrarily selected taking into consideration the degree of polymerization hindrance due to oxygen, resolving power, fogging, characteristic, refractive index variation and surface adhesion. Further, the layer constitution and the coating method of undercoating and overcoating can be performed according to circumstances.

Various photoinitiators can be selected for use in the above-described imaging systems. However, by far the most useful photoinitiators consist of an organic dye and an organic borate salt such as disclosed in U.S. Pat. Nos. 5,112,752; 5,100,755; 5,057,393; 4,865,942; 4,842,980; 4,800,149; 4,772,530; and 4,772,541. The photoinitiator is preferably used in combination with a disulfide coinitiator as described in U.S. Pat. No. 5,230,982 and an autoxidizer which is capable of consuming oxygen in a free radical chain process.

The amount of organic dye to be used is preferably in the range of from 0.1 to 5% by weight based on the total weight of the photopolymerization composition, preferably from 0.2 to 3% by weight. The amount of borate compound contained in the photopolymerization composition of the invention is preferably from 0.1% to 20% by weight based on the total amount of photopolymerization composition, more preferably from 0.3 to 5% by weight, and most preferably from 0.3% to 2% by weight.

The ratio between the organic dye and organoborate salt is important from the standpoint of obtaining high sensitivity and sufficient decolorization by the irradiation of light in the fixing step of the recording process described later. The weight ratio of the organic dye to the organoborate salt is preferably in the range of from 2/1 to 1/50, more preferably less than 1/1 to 1/20, most preferably from 1/1 to 1/10.

The organic dyes for use in the present invention may be suitably selected from conventionally known compounds having a maximum absorption wavelength falling within a range of 300 to 1000 nm. High sensitivity can be achieved by selecting a desired dye having the wavelength range within described above and adjusting the sensitive wavelength to match the light source to be used. Also, it is possible to suitably select a light source such as blue, green, or red, or infrared LED (light emitting diode), solid state laser, OLED (organic light emitting diode) or laser, or the like for use in image-wise exposure to light.

Specific examples of the organic dyes include 3-ketocoumarin compounds, thiopyrylium salts, naphthothiazolemerocyanine compounds, merocyanine compounds, and merocyanine dyes containing thiobarbituric acid, hemioxanole dyes, and cyanine, hemicyanine, and merocyanine dyes having indolenine nuclei. Other examples of the organic dyes include the dyes described in Chemistry of Functional Dyes (1981, CMC Publishing Co., Ltd., pp. 393-416) and Coloring Materials (60[4], 212-224, 1987). Specific examples of these organic dyes include cationic methine dyes, cationic carbonium dyes, cationic quinoimine dyes, cationic indoline dyes, and cationic styryl dyes. Examples of the above-mentioned dyes include keto dyes such as coumarin dyes (including ketocoumarin and sulfonocoumarin), merostyryl dyes, oxonol dyes, and hemioxonol dyes; nonketo dyes such as nonketopolymethine dyes, triarylmethane dyes, xanthene dyes, anthracene dyes, rhodamine dyes, acridine dyes, aniline dyes, and azo dyes; nonketopolymethine dyes such as azomethine dyes, cyanine dyes, carbocyanine dyes, dicarbocyanine dyes, tricarbocyanine dyes, hemicyanine dyes, and styryl dyes; quinoneimine dyes such as azine dyes, oxazine dyes, thiazine dyes, quinoline dyes, and thiazole dyes.

Preferably the organic dye useful for the invention is a cationic dye-borate anion complex formed from a cationic dye and an anionic organic borate. The cationic dye absorbs light having a maximum absorption wavelength falling within a range from 300 to 1000 nm and the anionic borate has four R groups, of which three R groups each represents an aryl group which may have a substitute, and one R group is an alkyl group, or a substituted alkyl group. Such cationic dye-borate anion complexes have been disclosed in U.S. Pat. Nos. 5,112,752; 5,100,755; 5,075.393; 4,865,942; 4,842,980; 4,800,149; 4,772,530; and 4,772,541 which are incorporated herein by reference.

When the cationic dye-borate anion complex is used as the organic dye in the photopolymerization compositions of the invention, it does not require to use the organoborate salt. However, to increase the photopolymerization sensitivity and to reduce the cationic dye stain, it is preferred to use an organoborate salt in combination with the cationic dye-borate complex. The organic dye can be used singly or in combination.

Specific examples of the above-mentioned water insoluble phenols are given below. However, it should be noted that the present invention is not limited to these examples.

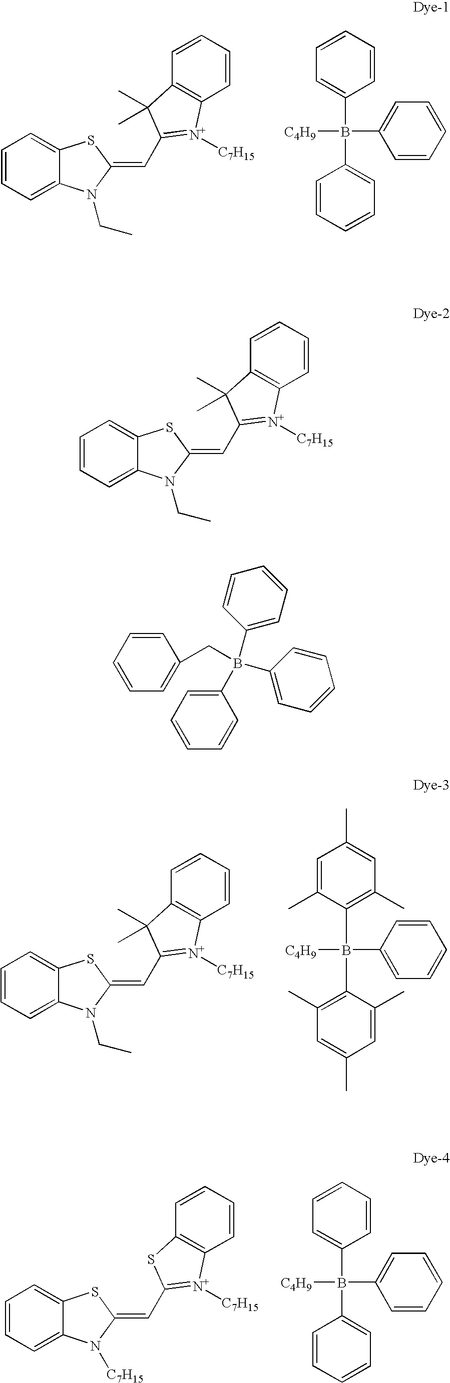

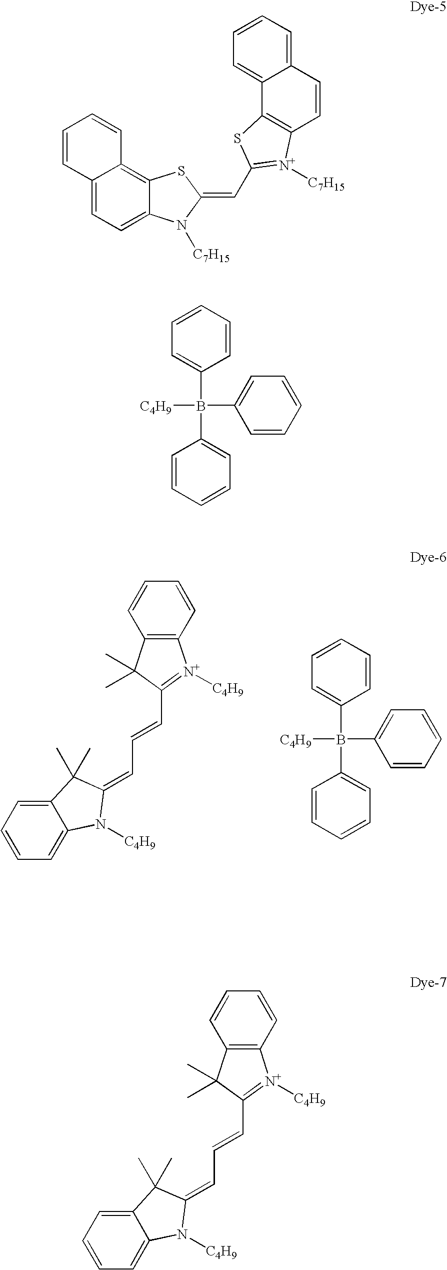

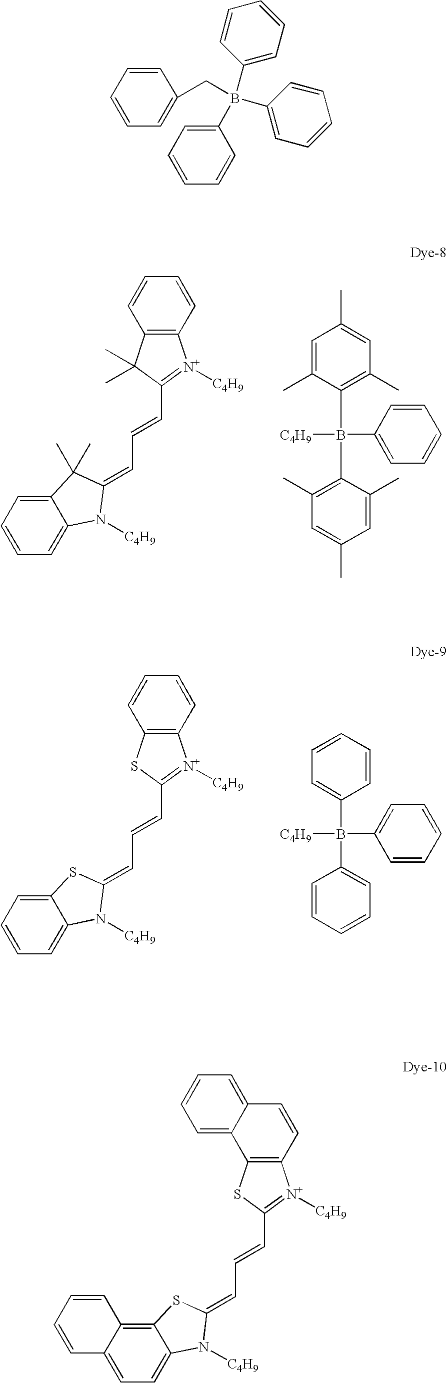

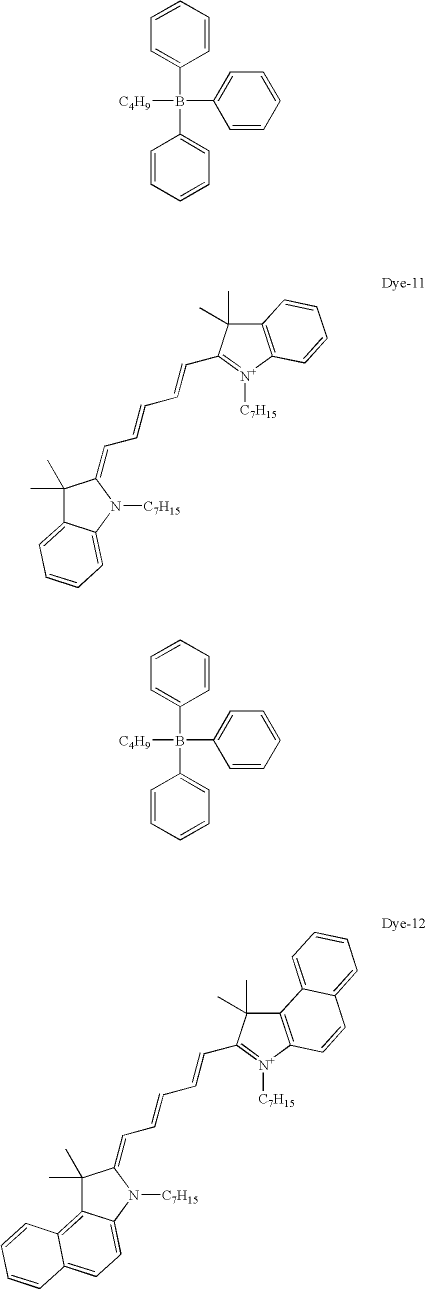

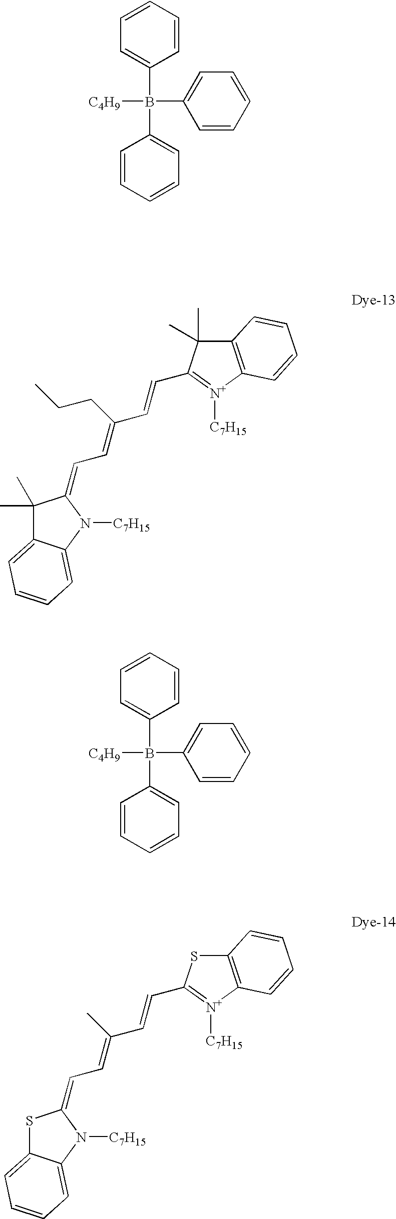

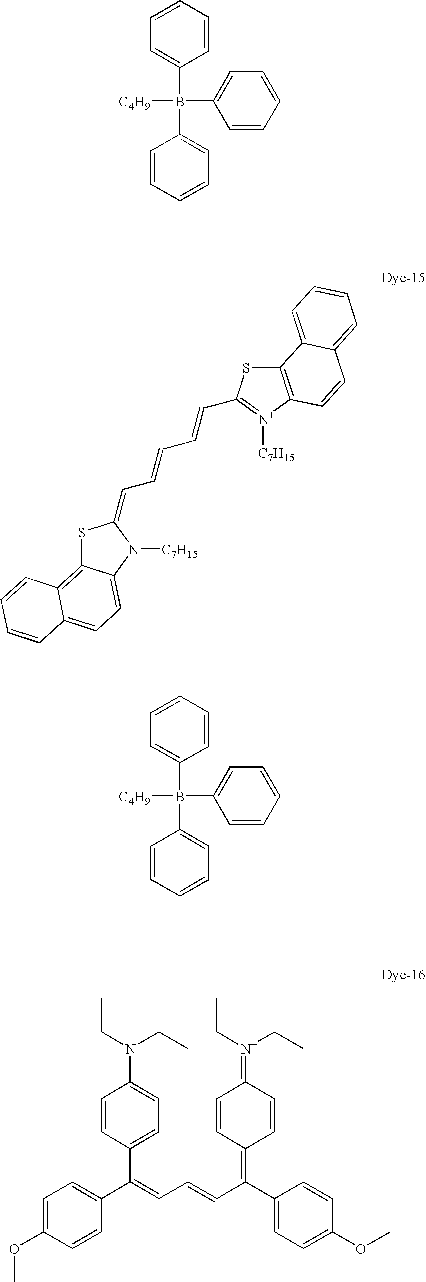

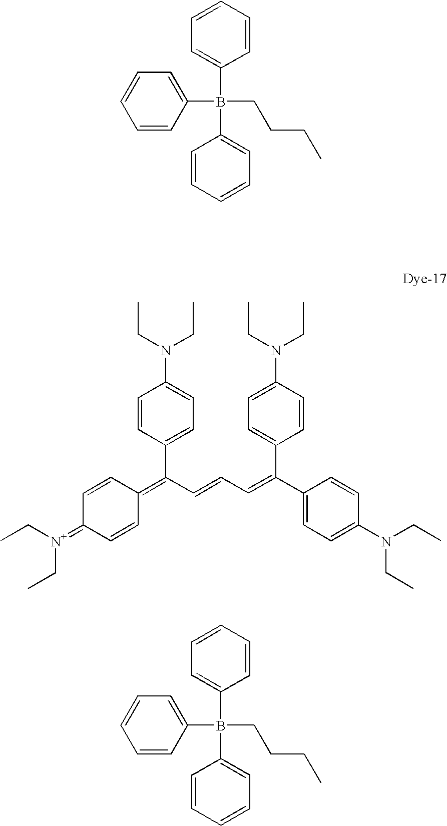

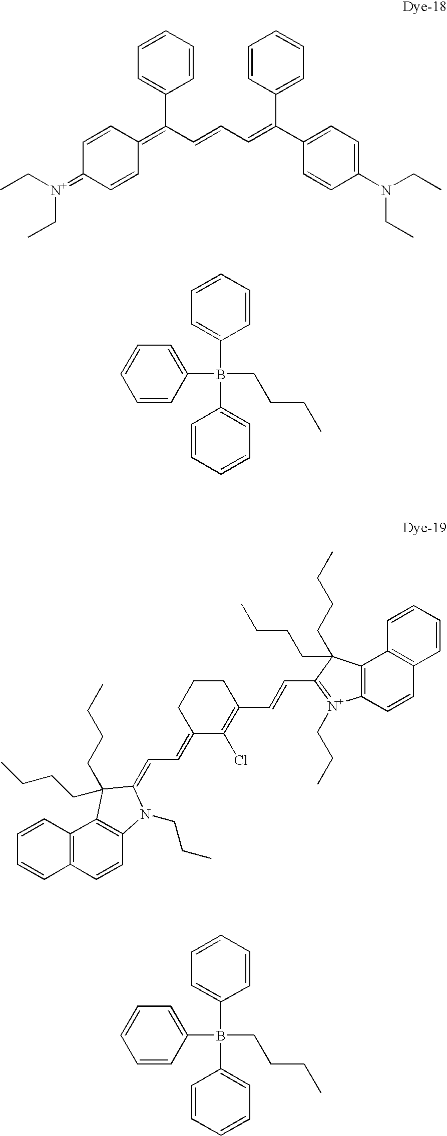

The borate salt useful for the photosensitive composition of the present invention is represented by the following general formula (1).
[BR₄]⁻Z⁺ [1]
where Z represents a group capable of forming cation and is not light sensitive, and [BR₄]⁻ is a borate compound having four R groups which are selected from an alkyl group, a substituted alkyl group, an aryl group, a substituted aryl group, an aralkyl group, a substituted aralkyl group, an alkaryl group, a substituted alkaryl group, an alkenyl group, a substituted alkenyl group, an alkynyl group, a substituted alkynyl group, an alicyclic group, a substituted alicyclic group, a heterocyclic group, a substituted heterocyclic group, and a derivative thereof. Plural Rs may be the same as or different from each other. In addition, two or more of these groups may join together directly or via a substituent and form a boron-containing heterocycle. Z⁺ does not absorb light and represents an alkali metal, quaternary ammonium, pyridinium, quinolinium, diazonium, morpholinium, tetrazolium, acridinium, phosphonium, sulfonium, oxosulfonium, iodonium, S, P, Cu. Ag, Hg, Pd, Fe, Co, Sn, Mo, Cr, Ni, As, or Se.

Specific examples of the above-mentioned borate salts are given below. However, it should be noted that the present invention is not limited to these examples.

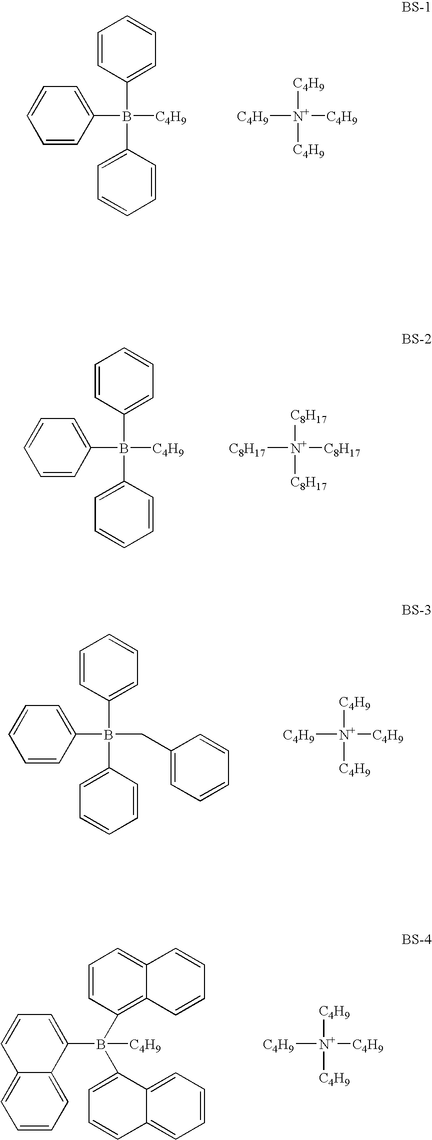

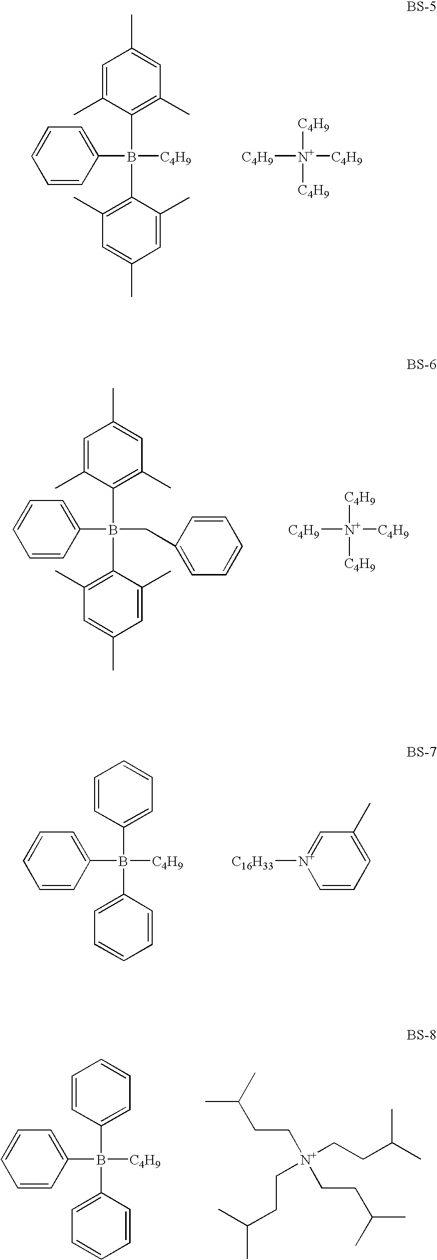

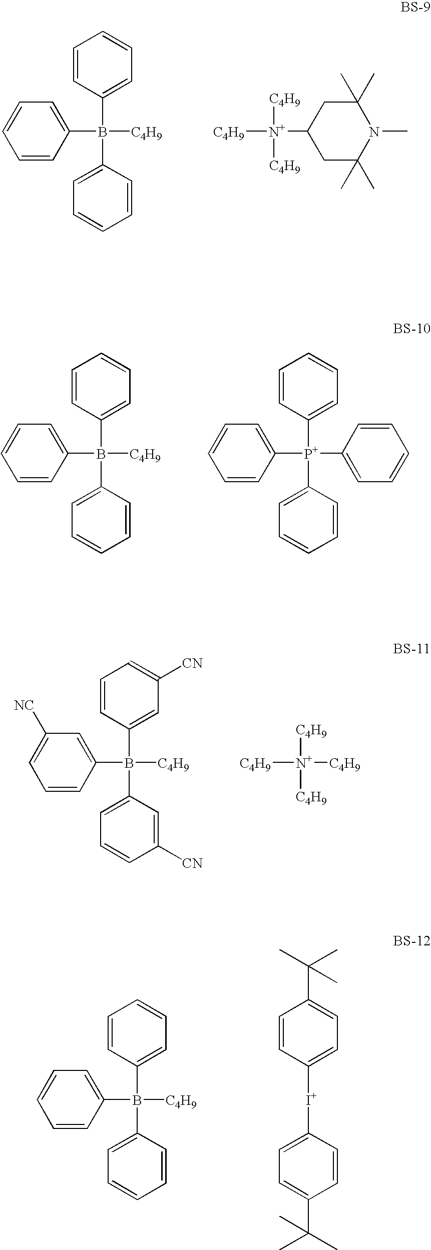

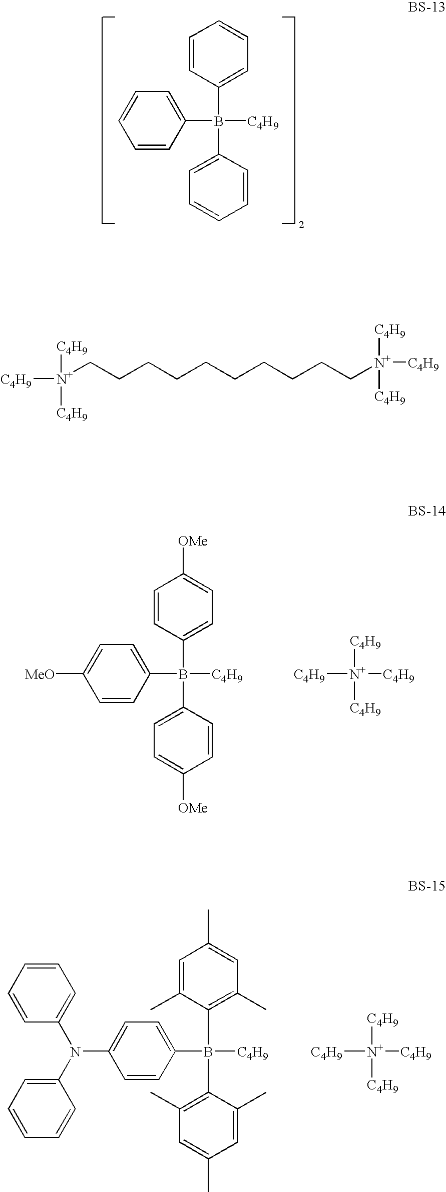

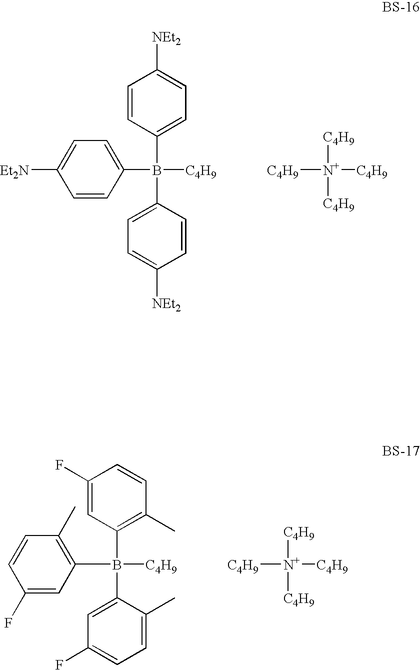

Various additives can be used together with the photoinitiator system to affect the polymerization rate. For example, a reducing agent such as an oxygen scavenger or a chain-transfer aid of an active hydrogen donor, or other compound can be used to accelerate the polymerization. An oxygen scavenger is also known as an autoxidizer and is capable of consuming oxygen in a free radical chain process. Examples of useful autoxidizers are N,N-dialkylanilines. Examples of preferred N,N-(dialkylanilines are dialkylanilines substituted in one or more of the ortho-, meta-, or para-position by the following groups: methyl, ethyl, isopropyl, t-butyl, 3,4-tetramethylene, phenyl trifluoromethyl, acetyl, ethoxycarbonyl, carboxy, carboxylate, trimethylsilymethyl, trimethylsilyl, triethylsilyl, trimethylgermanyl, triethylgermanyl, trimethylstannyl, triethylstannyl, n-butoxy, n-pentyloxy, phenoxy, hydroxy, acetyl-oxy, methylthio, ethylthio, isopropylthio, thio-(mercapto-), acetylthio, fluoro, chloro, bromo and iodo. Representative examples of N,N-dialkylanilines useful in the present invention are 4-cyano-N,N-dimethylaniline, 4-acetyl-N,N-dimethylaniline, 4-bromo-N,N-dimethylaniline, ethyl 4-(N,N-dimethylamino)benzoate, 3-chloro-N,N-dimethylaniline, 4-chloro-N,N-dimethylaniline, 3-ethoxy-N,N-dimethylaniline, 4-fluoro-N,N-dimethylaniline, 4-methyl-N,N-dimethylaniline, 4-ethoxy-N,N-dimethylaniline, N,N-dimethylaniline, N,N-dimethylthioanicidine, 4-tetramethyl-1,4-dimethylaniline, 4-acetamido-N,N-dimethylaniline, 2,6-diisopropyl-N,N-dimethylaniline, (DIDMA) 9.6-diethy]-N,N-dimethylaniline, N,N,2,4,6-pentamethylaniline (PMA) and p-t-butyl-N,N-dimethylaniline. In accordance with another aspect of the invention, the dye borate photoinitiator is used in combination with a disulfide coinitiator.

Examples of useful disulfides are described in U.S. Pat. No. 5,230,982 which is incorporated herein by reference. Two of the most preferred disulfides are mercaptobenzothiazo-2-yl disulfide and 6-ethoxymercaptobenzothiazol-2-yl disulfide. By using these disulfides as described in the referenced patent, the amount of the photoinitiators used in the microcapsules can be reduced to levels such that the background coloration or residual stain can be reduced significantly. At these low levels, the low-density image area color ation of the imaging layer does not detract unacceptably from the quality of the image. In addition, thiols, thioketones, trihalomethyl compounds, lophine dimer compounds, iodonium salts, sulfonium salts, azinium salts, organic peroxides, and azides are examples of compounds useful as polymerization accelerators.

Other additives which can be incorporated into the photopolymerization composition of the invention include various ultraviolet ray absorbers and hindered amine light stabilizers, photostabilizers as described in detail by J. F. Rabek in “Photostabilization of Polymers, Principles and Applications” published by Elsevier Applied Science in 1990.

Preferably the above-mentioned substantially colorless component E (developer) when added to the image forming unit of the present invention is in a dispersion form prepared by technique such as sand mill in the presence of a water-soluble polymer, a sensitizer, and other color-forming aid. The dispersion can also be prepared by a process comprising the steps of dissolving these components in an organic solvent, blending the resulting solution with a polymer aqueous solution (i.e., aqueous phase) containing a surfactant and/or water soluble-polymer as protective colloids, and emulsifying the blend by such means as a homogenizer, and removing the organic solvent by evaporation so as to obtain a dispersion for use. Preferably the particle size of the dispersion is less than 5 μm, preferably less than 2 μm. Preferably the particle size is greater than 0.1 μm.

The imaging element of the invention comprises a support and above the support a pressure developable image forming unit. In one embodiment, a multicolor image can be realized using an imaging element produced by producing a plurality of single-color image forming layers within the image forming unit, each of which contains microcapsules enclosing a color-forming component A designed to form a different color, and irradiating the imaging element with a plurality of light sources each having a different wavelength.

That is, the light sensitive and pressure developable imaging layer has a structure produced by providing on a support a first imaging layer which contains microcapsules containing a color-forming component for developing a yellow color and a photopolymerization composition sensitive to a light source having a central wavelength of λ₁, providing on top of the first imaging layer a second imaging layer which contains microcapsules containing a color-forming component for developing a magenta color and a photopolymerization composition sensitive to a light source having a central wavelength of λ₂, and providing on top of second imaging layer a third imaging layer which contains microcapsules containing a color-forming component for developing a cyan color and a photopolymerization composition sensitive to a light source having a central wavelength of λ₃. In addition, if necessary, the imaging layer may have an intermediate layer between the different colored imaging layers. The above-mentioned central wavelengths λ₁, λ₂, and λ₃ of the light sources differ from each other.

The light sensitive and pressure developable image forming unit of the present invention may have any number of the imaging layers. Preferably, the imaging layer may contain first to i^{th} layers, each layer is sensitive to light having a central wavelength different from the light having a central wavelength to which other layers are sensitive, and each layer develops a color different from that of other layers. For example, the first imaging layer is sensitive to light having a central wavelength of λ₁ and develops a color, a second imaging layer is sensitive to light having a central wavelength of λ₂ and develops a color different from the color of the first imaging layer, and an i^{th} imaging layer is sensitive to light having a central wavelength of λᵢ and develops a color different from the colors of i−1^{th} imaging layer.

The multicolor image can also be realized using an imaging element by producing a multicolor image forming unit in which all of the microcapsules are in one layer. The layer contains microcapsules of which each type contains a color-forming component A of a different color, is sensitive to light having a central wavelength different from the light having a central wavelength to which other types of microcapsules are sensitive, and develops a color different from the color other types develop. For example, the first type of microcapsule is sensitive to light having a central wavelength of λ₁ and develops a color, a second type is sensitive to light having a central wavelength of λ₂ and develops a color different from the color of the first type of microcapsules, and an i^{th} type of microcapsules is sensitive to light having a central wavelength of λᵢ and develops a color different from the colors of i−1^{th} type of microcapsules. In the present invention, i is preferably any integer selected from 1 to 10, more preferably any integer selected from 2 to 6, and most preferably any integer selected from 2 to 4.

When images are formed using an imaging material having a multicolor image forming unit like the one for use in the present invention, the exposure step consists of image-wise exposure using plural light sources whose wavelengths match the absorption wavelengths of the imaging layers, respectively, and are different from each other. This exposure enables the imaging layers whose absorption wavelengths match the wavelengths of the respective light sources to form latent images selectively. Because of this, multicolor images can be formed with a high sensitivity and in high sharpness. Furthermore, since the background, which is colored with such compounds as a spectral sensitizing compound and a photopolymerization initiator, can be decolorized by irradiating the imaging layer surface with light, high-quality images having a high contrast can be formed.

The light sensitive and pressure developable image forming unit or imaging layers of the invention also contain a binder material. There is no limitation on the choice of the binder material as far as it is compatible with other components incorporated in the layer or unit. The binder material includes, for example, water-soluble polymers, water dispersible polymers, and latex. Specific examples include proteins, protein derivatives, cellulose derivatives (e.g., cellulose esters), polysaccharides, casein, and the like, and synthetic water permeable colloids such as poly(vinyl lactams), acrylamide polymers, poly(vinyl alcohol) and its derivatives, hydrolyzed polyvinyl acetates, polymers of alkyl and sulfoalkyl acrylates and methacrylates, polyamides, polyvinyl pyridine, acrylic acid polymers, maleic anhydride copolymers, polyalkylene oxide, methacrylamide copolymers, polyvinyl oxazolidinones, maleic acid copolymers, vinyl amine copolymers, methacrylic acid copolymers, acryloyloxyalkyl sulfonic acid copolymers, vinyl imidazole copolymers, vinyl sulfide copolymers, and homopolymer or copolymers containing styrene sulfonic acid. Binder also include dispersions made of solvent soluble polymers such as polystyrene, polyvinyl formal, polyvinyl butyral, acrylic resins. e.g., polymethyl acrylate, polybutyl acrylate, polymethyl methacrylate, polybutyl methacrylate, and copolymers thereof, phenol resins, styrene-butadiene resins, ethyl cellulose, epoxy resins, and urethane resins, and latices of such polymers.

The binder is preferably cross-linked so as to provide a high degree of cohesion and adhesion. Cross-linking agents or hardeners which may effectively be used in the coating compositions of the present invention include aldehydes, epoxy compounds, polyfunctional aziridines, vinyl sulfones, methoxyalkyl melamines, triazines, polyisocyanates, dioxane derivatives such as dihydroxydioxane, carbodiimides, chrome alum, zirconium sulfate, and the like.

The light sensitive and pressure developable image forming unit or imaging layer thereof may also contain various surfactants for such purposes as a coating aid, an antistatic agent, an agent to improve sliding properties, an emulsifier, and an adhesion inhibitor.

Examples of the surfactant that can be used include nonionic surfactants such as saponin, polyethylene oxide, and polyethylene oxide derivatives, e.g., alkyl ethers of polyethylene oxide-anionic surfactants such as alkylsulfonates, alkylbenzenesulfonates, alkylnaphthalenesulfonates, alkylsulfuric esters. N-acyl-N-alkyltaurines, sulfosuccinic esters, and sulfoalkylpolyoxyethylene alkylphenyl ethers; amphoteric surfactants such as alkylbetaines and alkylsulfobetaines; and cationic surfactants such as aliphatic or aromatic quaternary ammonium salts.

Furthermore, if necessary the light sensitive and pressure developable image forming unit or an imaging layer thereof may contain additives other than those described above, for example, dyes, ultraviolet absorbing agents, plasticizers, fluorescent brighteners, matting agents, coating aids, hardeners, antistatic agents, and sliding property-improving agents. Typical examples of these additives are described in Research Disclosure, Item 17643, Vol. 176, December 1978, and Research Disclosure, Item 18716, Vol. 187, November 1979.

In the imaging element of the present invention, the imaging material uses color-forming component A which is encapsulated in microcapsules. For the encapsulation, a conventionally known method can be employed. Examples of the method include a method utilizing coacervation of a hydrophilic wall-forming material described in U.S. Pat. Nos. 2,800,457 and 2,800,458; an interfacial polymerization method described in U.S. Pat. No. 3,287,154; U.K. Patent 990,443; and JP-B Nos. 38-19574; 42-446; and 42-771; a method utilizing polymer deposition described in U.S. Pat. Nos. 3,418,250 and 3,660,304; a method utilizing an isocyanate-polyol wall forming material described in U.S. Pat. No. 3,796,669; a method utilizing an isocyanate wall forming material described in U.S. Pat. No. 3,914,511; a method utilizing urea-formaldehyde and urea-formaldehyde-resorcinol wall-forming materials described in U.S. Pat. Nos. 4,001,140; 4,087,376; and 4,089,802; a method utilizing wall-forming materials such as a melamine-formaldehyde resin and hydroxypropylcellulose described in U.S. Pat. No. 4,025,455; an in-situ method utilizing a polymerization of monomers described in JP-B No. 36-9168 and JP-A No. 51-9079; a method utilizing electrolytic dispersion cooling described in U. K. Patents 952,807 and 965,074; and a spray-drying method described in U.S. Pat. No. 3,111,407 and U. K. Patent 930.442.

The encapsulating method is not limited to the methods listed above. However, in the imaging material of the present invention, it is particularly preferable to employ an interfacial polymerization method comprising the steps of mixing an oil phase, prepared by dissolving or dispersing the color-forming component in a hydrophobic organic phase that becomes the core of the microcapsules, and an aqueous phase having a water-soluble polymer dissolved therein, emulsifying the mixture by means of a homogenizer or the like, and heating the emulsion so as to cause a polymer-forming reaction at the interface of droplets so that polymeric microcapsule walls are formed. This method makes it possible to form microcapsules having uniform particle diameters in a short period of time and to obtain a imaging material excellent in storability as a raw imaging material.

The reactants that form the polymer are added to the inside of the droplets and/or the outside of the droplets. Examples of the polymeric substance include polyurethane, polyurea, polyamide, polyester, polycarbonate, urea/formaldehyde resins, melamine resins, polystyrene, styrene/methacrylate copolymers, styrene/acrylate copolymers, and so on. Among these substances, polyurethane, polyurea, polyamide, polyester, and polycarbonate are preferable, and polyurethane and polyurea are particularly preferable. The above-listed polymeric substances may be used in combinations of two or more kinds.

The water-soluble polymer, which is present as protective colloids in the aqueous phase to be mixed with the oil phase, may be selected appropriately from conventionally known anionic polymers, nonionic polymers, and amphoteric polymers. Examples of the anionic polymer that can be used include natural ones and synthetic ones. Some examples are polymers having such groups as —COO—, —SO₂—, and the like. Specific examples thereof include naturally occurring substances such as gum arabic, alginic acid, and pectin; semisynthetic products such as carboxymethyl cellulose, gelatin derivatives, e.g., phthalated gelatin, sulfated starch, sulfated cellulose, and ligninsulfonic acid; and synthetic products such as maleic anhydride-based (including hydrolysate) copolymers, acrylic acid-based (including methacrylic acid-based) polymers and copolymers, vinylbenzenesulfonic acid-based polymers and copolymers, and carboxy-modified polyvinyl alcohol. Examples of the nonionic polymer include polyvinyl alcohol, hydroxyethyl cellulose, and methylcellulose. Examples of the amphoteric polymer include gelatin and the like. The water-soluble polymers are used as 0.01 to 10% by mass solutions.

A surfactant can also be incorporated in the aqueous phase. The surfactant can be suitably selected from anionic or nonionic surfactants that do not cause precipitation or flocculation by interacting with the protective colloids. Preferred examples of the surfactant include sodium alkylbenzenesulfonate, sodium alkylsulfate, sodium dioctylsulfosuccinate, and polyalkylene glycol (e.g., polyoxyethylene nonylphenyl ether).

When polyurethane is used as a microcapsule wall material, the microcapsule wall can be formed by mixing a polyvalent isocyanate and a second substance (e.g., polyol or polyamine) that reacts therewith to form the microcapsule wall in a water-soluble polymer aqueous solution (i.e., aqueous phase) or in an oily medium (oil phase) to be encapsulated, emulsifying the mixture, and heating the resulting emulsion so as to cause a polymer-forming reaction at the interface of droplets. As the polyvalent isocyanate and the polyol or polyamine, with which the polyvalent isocyanate reacts, those which are described in U.S. Pat. Nos. 3,281,383, 3,773,695, and 3,793,268, and JP-B Nos. 48-40347 and 49-24159, and JP-A Nos. 48-80191 and 48-84086 can be used.

When microcapsules containing the color-forming component are prepared, the color-forming component to be enclosed in the microcapsules may be present in a solution state or may be present in solid state inside the microcapsules at room temperature. If it is in the solution state, the color-forming component is mixed with an organic solvent having high boiling point to form the microcapsule core. If it is in the solid states, the color former is dissolved in a thermal solvent or an auxiliary solvent. An auxiliary solvent is removed after encapsulation. The microcapsule core comprises mostly the color-forming component together with other additives. The thermal solvent is a solid at room temperature and becomes a liquid at elevated temperatures, for example, at curing temperatures during the encapsulation process. In this case, the microcapsule core comprises the color-forming component dispersed in a thermal solvent.

A thermal solvent in this invention is defined as compounds which is a solid at temperatures of less than 30° C. and become a liquid at temperatures of greater than 30° C., preferably greater than 40° C. Typical thermal solvents include 1,12-dihydroxydodecane, paraffin wax, bees wax, fatty acid, fatty acid amide, stearic acid, steramide, zinc stearate, and more preferably hindered phenols such as 2,6-di-t-butyl-4-methylphenol (BHT), thiodiethylene hydrocinnamate (IRGANOX™ 1035 from Ciba-Geigy Corp.) tetrakis methane (IRGANOX™ 1010 from Ciba Geigy Corp.), bisphenol A diacetate (BPADA), diphenyl phthalate, dicyclohexyl phthalate, diphenyl oxalate, benzyl oxynaphthalene, 1-hydroxy-2-naphthoate, rosin and m terphenyl derivatives, bis-dialkylaryl ethane such as 1,2-bis(3.4-dimethylphenyl)ethane, those disclosed in U.S. Pat. Nos. 4,885,271 and 4,885,271.

In a preferred embodiment of the invention, the color-forming component is mixed together with a photopolymerization composition to form the microcapsule core, or microcapsule internal phase. The microcapsule shell or the microcapsule wall material is a polyurea, or polyurethane-urea. In another preferred embodiment of the invention, the color-forming component is mixed together with a photopolymerization composition to form the microcapsule core, or microcapsule internal phase. The microcapsule shell or the microcapsule wall material comprises a polyurea shell or a polyurethane-urea shell and a melamine-formaldehyde or urea-formaldehyde shell.

Preferably the microcapsule containing the color-forming component A is prepared by the steps of dissolving the color-forming component A in an auxiliary organic solvent such as ethyl acetate, or a thermal solvent, or the a photopolymerization composition to form a solution, adding to the solution a certain amount of a microcapsule wall material such as a polyfunctional isocynate to form the oil phase, adding the oil phase to an aqueous solution comprising a water soluble polymer such as polyvinyl alcohol or phthalated gelatin as the protective colloid, and optionally a surfactant, to form a mixture, emulsifying the mixture with a homogenizer to form an emulsion, optionally adding to the emulsion a polyfunctional amine as the curing agent, and curing the emulsion at elevated temperature to form the microcapsule.

If it is desirable to form a second shell, an aqueous solution of melamine and formaldehyde or a precondensate is added to the above emulsion. The melamine-formaldehyde shell is formed by raising the temperature of the resulting mixture at neutral or acidic pH. e.g., pH of 7 or less. The temperature of encapsulation is maintained at about 20 to 95° C., preferably about 30 to 85° C. and more preferably about 45 to 80° C.

The average particle diameter of the microcapsules for use in the imaging material of the present invention is preferably 20 μm or less, more preferably 10 μm or less, and most preferably 6 μm or less from the standpoint of obtaining high resolution. The average particle diameter is preferably 0.1 μm or greater because, if the average particle diameter of the microcapsules is too small, the surface area per unit amount of the solid components becomes larger and a lager amount of wall-forming materials is required.

Examples of the support for use in the imaging material of the present invention include paper; coated paper; synthetic paper such as laminated paper; films such as polyethylene terephthalate film, cellulose triacetate film, polyethylene film, polystyrene film, and polycarbonate film; plates of metals such as aluminum, zinc, and copper; and these supports whose surface is treated with a surface treatment, a subbing layer or metal vapor deposition. A further example is the support described in Research Disclosure, Item 20036 XVII, Vol. 200, December 1980. These supports may contain a fluorescent brightener, a bluing dye, a pigment, or other additives. Furthermore, the support itself may be made of an elastic sheet such as a polyurethane foam or rubber sheet. Between a support and the light sensitive and pressure developable image forming unit, a layer, which comprises a polymer such as gelatin, polyvinyl alcohol (PVA), or the like having a low oxygen transmission rate, can be provided. The presence of this layer makes it possible to effectively prevent the fading due to photooxidation of the images formed.

The image element of the present invention can contain at least one electrically conductive layer, which can be either surface protective layer or a sub layer. The surface resistivity of at least one side of the support is preferably less than 1×10¹² Ω/square, more prefer-ably less than 1×10¹¹ Ω/square at 25° C. and 20 percent relative humidity. To lower the surface resistivity, a preferred method is to incorporate at least one type of electrically conductive material in the electrically conductive layer. Such materials include both conductive metal oxides and conductive polymers or oligomeric compounds. Such materials have been described in detail in, for example, U.S. Pat. Nos. 4,203,769; 4,237,194; 4,272,616; 4,542,095; 4,582,781; 4,610,955; 4,916,011; and 5,340,676.

The image element of the invention can contain a curl control layer or a backing layer located opposite of the support to the imaging forming unit for the purposes of improving the machine-handling properties and curl of the recording element, controlling the friction and resistivity thereof, and the like. Typically, the backing may comprise a binder and a filler and optionally a lubricant. Typical fillers include amorphous and crystalline silicas, poly(methyl methacrylate), hollow sphere polystyrene beads, micro-crystalline cellulose, zinc oxide, and talc. The filler loaded in the backing is generally less than 5 percent by weight of the binder component, and the average particle size of the filler material is in the range of 1 to 30 μm. Examples of typical binders used in the backing are polymers such as polyacrylates, gelatin, polymethacrylates, polystyrenes, polyacrylamides, vinyl chloride-vinyl acetate copolymers, poly(vinyl alcohol), gelatin, and cellulose derivatives. Lubricants can be same as those incorporated in the outer protective layer located in the opposite side to the backing layer. Additionally, an antistatic agent also can be included in the backing to prevent static hindrance of the image element. Particularly suitable antistatic agents are compounds such as dodecylbenzenesulfonate sodium salt, octylsulfonate potassium salt, oligostyrenesulfonate sodium salt and laurylsulfosuccinate sodium salt, and the like. The antistatic agent may be added to the binder composition in an amount of 0.1 to 15 percent by weight, based on the weight of the binder. An image forming unit may also be coated on the backside, if desired.

Visible images can be made by pressure development of the imaging element. The pressure development can be carried out either simultaneously with the exposure for latent image formation or after the exposure.

The pressure development can be accomplished with a pressure applicator device. For example, the imaging material is developed by passing an exposed imaging media between a pair of calendar rollers that rupture the microcapsules, thereby allowing contact between the color-forming component and a developer that react to develop the image. The imaging material can also be developed by moving a point contact which is resiliently biased into engagement with the imaging sheet. Typically, the imaging sheet is secured to a cylinder and the point contact is positioned in resilient pressure contact with the imaging sheet. As the cylinder is rotated, the point contact is simultaneously moved along the cylinder in synchronism with the rotation of the cylinder to rupture the microcapsules and develop the image in the imaging sheet, or the imaging sheet may be mounted on a planer platform and the point contact is moved across the surface of the sheet using a screw thread in an X-Y transport device. The pressure that is to be applied is preferably 10 to 300 kg/cm² n more preferably 80 to 250 kg/cm², and most preferably 130 to 200 kg/cm². If the pressure is less than 10 kg/cm², sufficient density of developed color may not be obtained, whereas, if the pressure exceeds 300 kg/cm², the discrimination of the images may not be sufficient because even the hardened microcapsules are broken.

The imaging element of the invention is exposed image-wise to light according to the pattern of a desired image shape so that the photopolymerization forms a latent image. The color development step is accomplished pressure so that the color-forming components develop colors according to the latent image to thereby produce images. There is then a fixing step in which the imaging layer surface is irradiated with light so as to fix the image formed and decolorize the organic dyes.

In the exposure step, it is possible to employ, for example, a means for exposing the whole face to an amount of light which has wavelengths corresponding to the sensitive regions of respective colors and can provide a desired density of the developed color. The light source for use in the exposure step may be any light source selected from the light sources having wavelengths ranging from ultraviolet to infrared light if the imaging layer contains a light-absorbing material such as a spectral sensitizing compound that exhibits an absorption in a specific wavelength region. More specifically, a light source providing maximum absorption wavelengths ranging from 300 to 1000 nm is preferable. It is preferable to select and use a light source whose wavelength matches the absorption wavelength of the light-absorbing material such as an organic dye to be used. The selective use of such light-absorbing material enables the use of a blue to red light source and the use of a small-sized, inexpensive infrared laser device and consequently, not only broadens the use of the imaging material of the present invention, but also raises sensitivity and image sharpness. Among the light sources, it is particularly preferable to use a laser light source such as a blue, green, or red laser light source or an LED from the viewpoint of simplicity, downsizing, and low cost of the device.

According to the image imaging, process of the present invention, after the color development step, the image forming unit surface is subjected to a fixing step in which the whole imaging layer surface is irradiated with light from a specific light source to fix the images formed and to decolorize photopolymerization initiator components remaining in the imaging layer. As for the light source that can be used in the fixing step, a wide range of light sources, such as a mercury lamp, an ultrahigh pressure mercury lamp, an electrodeless discharge-type mercury lamp, a xenon lamp, a tungsten lamp, a metal halide lamp, and a fluorescent lamp can be suitably used. The method of irradiating the image forming unit with light from the light source in the fixing step is not particularly limited. The whole image forming unit surface may be irradiated with light at one time, or the image forming unit surface may be gradually irradiated with light by scanning or the like until the irradiation of the surface finally ends. That is, any method that finally enables the irradiation of the entire surface of the image forming unit material after image formation with nearly uniform light may be employed. The irradiation of the entire image forming unit layer is preferable from the standpoint of the enhancement of the effects of the present invention.

The duration of the irradiation with light from the light source needs to be the time period that allows the produced images to be fixed and the background to be sufficiently decolorized. In order to perform sufficient fixing of images and decolorization, the duration of the irradiation is preferably in the range of several seconds to tens of minutes and more preferably in the range of several seconds to several minutes.

The following examples are intended to illustrate but not to limit the invention.

### EXAMPLE

Sample 1

Paper base was produced for a photographic quality “control” sample or benchmark using a standard fourdrinier paper machine and a blend of mostly bleached hardwood Kraft fibers. The fiber ratio consisted primarily of bleached poplar (38%) and maple/beech (37%) with lesser amounts of birch (18%) and softwood (7%). Fiber length was reduced from 0.73 mm length weighted average as measured by a Kajaani FS-200 to 0.55 mm length using high levels of conical refining and low levels of disc refining. Fiber Lengths from the slurry were measured using a FS-200a Fiber Length Analyzer (Kajaani Automation, Inc.). Paper was made for sample 1 to a 173 g/m² basis weight with acid sizing chemistry; surface sizing using hydroxyethylated starch and sodium chloride was also employed on the control samples but is not critical for the comparison. The paper was then calendered to an apparent density of 1.08 g/cc. The paper was then extrusion coated on one side with a blend of polyethylene, colorants, TiO₂ at 27.4 g/m² and on the other side coated with 23.4 g/m² of a polyethylene blend.

Sample 2

Sample 2 is one example of the invention described. A commercially available mineral filled, high density (1.19 g/cc), polypropylene synthetic paper was coextruded on one side with 2 layers of polyolefin resins. The outermost skin layer was a polyethylene that also included colorants, 10% TiO₂, and stabilizer. The inner flange layer was a polypropylene that included 5% TiO₂ and 5% talc as well as stabilizers. Coverage of the coextruded layer was 19.5 g/m². The non image side was coated with 19.5 g/m² as well, of the same flange blend.

Sample 3

A control sample utilizing an alternative commercially available mineral filled polypropylene synthetic paper possessing a 0.71 g/cc core density was also created. Similar extrusion coating was performed as described in Sample 2.

Sample 4

A control sample utilizing an alternative commercially available mineral filled polypropylene synthetic paper possessing a 0.6 g/cc core density was also created. Similar extrusion coating was performed as described in Sample 2.

Sample 5

A second inventive sample utilizing an alternative commercially available mineral filled polypropylene synthetic paper possessing a 1.02 g/cc core density was also created. Similar extrusion coating was performed as described in Sample 2.

Stiffness was measured using a Lorentzen and Wetter type tester according to Tappi Method T 556. The bending resistance in milliNewtons of a 20 mm wide vertically clamped sample is measured for a 15° deflection angle.

TABLE 1

| | Machine Direction | Cross Direction | Average |
|---|---|---|---|
| | Stiffness | Stiffness | Stiffness |
| Sample 1 | 198 | 106 | 152 mN |
| (photo comparison) | | | |
| Sample 2 | 163 | 138 | 151 mN |

Table I demonstrates that a commercially available synthetic paper core, extrusion coated with polyolefin flange and skin layers can be used to provide a photo quality feel to the base media. Although MD and CD stiffness may not match traditional photo papers, the average stiffness, a key to customer perception, may be almost exactly matched.

The performance of each paper base substrate was evaluated by coating each substrate with a light sensitive material comprising light and pressure-response microcapsules enclosing a color-forming component, a polymerizable compound, and a photopolymerization initiator. Outside the microcapsules was a substantially colorless developer designed to react with the color-forming component to develop a color. The coated substrates were then evaluated by placing each sample on a heated vacuum platen at 100° F. The platen is then mechanically moved under an exposing device comprising red, green, and blue LED's further comprising a step format neutral attenuation tablet. Once exposed, the platen is then mechanically moved to the processing position and a spring loaded (3.2625# force) steel ball (3/16″ in diameter) is moved across the sample traveling in a bi-directional fashion at approximately 2000 mm/sec having a pitch of roughly 0.10 mm. After processing, the platen is returned to its original position, the sample is manually removed and placed on a heated surface (Digital Hot Plate, Omega LHS-722A) with a heated, 1 Kg aluminum weight on top of the sample for 10 sec to fix the image (both surfaces are at 90° C.). The sample is then removed from the heated surface and photobleached by placing the image side of the sample directly under a 500 watt fluorescent work light (Lights of America) for 10 sec to remove any colorants from residual photoinitiator. This procedure was repeated for each of the coated substrates. The optical densities of the final images were measured at step 1 of the neutral channel (region of maximum density, Dmax, and corresponds to the lowest exposure) using an X-Rite 820TR™ Densitometer. The red, green, and blue densities in this region were measured and recorded. The plot below represents these densities as a function of core density (g/cc) of each paper base substrate tested.

TABLE 2

| | Core Density g/cc | Avg. Image Density |
|---|---|---|
| Sample 1 (photo comparison) | 1.1 | 1.7 |
| Sample 2 | 1.2 | 1.7 |
| Sample 3 | .71 | 1.5 |
| Sample 4 | .6 | 1.5 |
| Sample 5 | 1.0 | 1.7 |

Table 2 shows clearly the relationship between core density of the substrate and final image density. Final image density may be shifted up or down with changes to the emulsion package, but the image differences between the samples will remain significant. Sample 1 provides good Dmax, but an observable paper fiber pattern was present in the developed image.

Colorimetry of the samples was measured on an UltraScan XE Colorimeter made by Hunter Associates Laboratory using D 6500 light source. Colorimetry was obtained using the total spectrum range (UV in) and with ultraviolet irradiation filtered out (UV out). Measurements were read in CIELAB units (L*, a*, b* and whiteness) with the samples backed by black and backed by white (baryta coated). Opacity was measured according to ASTM method E308-96, specular reflectance was included, and the testing was done by measuring one sheet black by black and then black by white (Baryta).

TABLE 3
Colorimetry-HUNTER COLORIMETRY

| | uvo | | | |
|---|---|---|---|---|
| Sample ID | L*-average | a*-average | b*-average | Opacity |
| Sample 1 | 94.01 | −0.36 | −2.65 | 93.2 |
| Sample 2 | 93.8 | −.26 | −4.99 | 94.9 |

Table 3 demonstrates that colorimetry of a traditional photographic base may be closely matched with regard to L* uvo and opacity. a* and b* may be adjusted with colorants as needed. Typically a slightly bluer white base has been desired in traditional photo prints.

The invention has been described in detail with particular reference to certain preferred embodiments thereof, but it will be understood that variations and modifications can be effected within the spirit and scope of the invention.

1. A pressure developable imaging element comprising a support and an image forming unit comprising photosensitive microcapsules and a developer, wherein said support comprises a substrate comprising polyolefin or a copolymer thereof, wherein said substrate has a density of greater than 0.9 grams/cc.

2. The pressure developable imaging element of claim 1 wherein the polyolefin substrate has a density of greater than 1.0 grams/cc.

3. The pressure developable imaging element of claim 1 wherein the polyolefin substrate has a density of 1.1 grams/cc to 1.6 grams/cc.

4. The pressure developable imaging element of claim 1 wherein the support is opaque.

5. The pressure developable imaging element of claim 4 wherein the opacity is greater than 92.

6. The pressure developable imaging element of claim 1 wherein the support has the following values: L* is 92 to 99, a* is −1 to +1 and b* is −10 to 0.

7. The pressure developable imaging element of claim 1 wherein the polyolefin is polypropylene, polyethylene, polypropylene co-polymer derivatives, or polyethylene co-polymer derivatives.

8. The pressure developable imaging element of claim 7 wherein said polyolefin is polypropylene or a polypropylene copolymer derivative.

9. The pressure developable imaging element of claim 1 wherein the polyolefin substrate further comprises a filler.

10. The pressure developable imaging element of claim 9 wherein said filler comprises white pigment.

11. The pressure developable imaging element of claim 10 wherein said white pigment is titanium dioxide, calcium carbonate, zinc sulfide, barium sulfate, or alkaline metal silicates.

12. The pressure developable imaging element of claim 1 wherein the caliper of the polyolefin substrate is between and including 100 μm and 250 μm.

13. The pressure developable imaging element of claim 1 wherein the polyolefin substrate is oriented.

14. The pressure developable imaging element of claim 13 wherein the polyolefin substrate is biaxially oriented.

15. The pressure developable imaging element of claim 13 wherein the polyolefin substrate is uniaxially oriented.

16. The pressure developable imaging element of claim 1 wherein the support further comprises at least one unoriented flange layer comprising polyolefin or a copolymer thereof.

17. The pressure developable imaging element of claim 16 wherein the unoriented flange layer is melt extruded.

18. The pressure developable imaging element of claim 16 wherein the polyolefin is polypropylene, polyethylene, polyester, polystyrene, or co-polymers thereof.

19. The pressure developable imaging element of claim 16 wherein the unoriented flange layer comprises an inorganic stiffening agent.

20. The pressure developable imaging element of claim 19 wherein said inorganic stiffening agent is an inorganic metal silicate, carbonate, talc, or glass fibers.

21. The pressure developable imaging element of claim 16 wherein said unoriented flange layer further comprises colorants.

22. The pressure developable imaging element of claim 1 wherein the stiffness of the element is between 50 and 300 mN.

23. The pressure developable imaging element of claim 16 wherein the unoriented flange layer has a caliper between and including 10 μm and 175 μm.

24. The pressure developable imaging element of claim 1 wherein the modulus of the polyolefin substrate is between and includes 30 MPa and 1000 MPa.

25. The pressure developable imaging element of claim 16 wherein the modulus of the unoriented flange layer is between and includes 700 MPa to 10500 MPa.

26. The pressure developable imaging element of claim 16 wherein the support comprises two unoriented flange layers and the polyolefin substrate is between the two unoriented flange layers.

27. The pressure developable imaging element of claim 16 wherein the unoriented flange layer adheres to gelatin.

28. The pressure developable imaging element of claim 1 wherein the support is substantially free of paper fiber.

29. The pressure developable imaging element of claim 1 further comprising an adhesive layer.

30. The pressure developable imaging element of claim 1 wherein the imaging element further comprises an inner protective layer and an outer protective layer on the opposite side of the image forming unit from the support.

31. The pressure developable imaging element of claim 1 wherein the imaging element further comprises at least one non-imaging layer comprising a hydrophilic colloid located between the support and the imaging unit.

32. The pressure developable imaging element of claim 31 wherein the hydrophilic colloid of the non-imaging layer is gelatin.

34. The pressure developable imaging element of claim 1 wherein the polyolefin substrate further comprises a cross-linker.
